(19) United States
(12) Patent Application Publication
(10) Pub. No.: US 2016/0006815 A1
(43) Pub. Date: Jan. 7, 2016

(54) INFORMATION MODELING FOR THE FUTURE INTERNET OF THINGS

(71) Applicant: INTERDIGITAL PATENT HOLDINGS, INC., Wilmington, DE (US)

(72) Inventors: Lijun Dong, San Diego, CA (US); Chonggang Wang, Princeton, NJ (US); Dale N. Seed, Allentown, PA (US)

(73) Assignee: InterDigital Patent Holdings, Inc., Wilmington, DE (US)

(21) Appl. No.: 14/768,878

(22) PCT Filed: Feb. 19, 2014
(86) PCT No.: PCT/US14/17189

§ 371 Date: Aug. 19, 2015

Related U.S. Application Data
(60) Provisional application No. 61/766,482, filed on Feb. 19, 2013.

(51) Int. Cl. H04L 29/08

(52) U.S. Cl. CPC H04L 67/12; H04L 67/06

(57) ABSTRACT

A method and apparatus for communication between multiple entities in an Internet of Things (IoT) are described herein. The method comprises receiving a first information wherein the first information comprises a first instance of a category of information, wherein the first instance comprises a field which relates to a second instance of a category of information, and wherein the first instance and second instance are each selected from the group consisting of an IoT content category; an IoT context category; an IoT policy category; an IoT decision category; an IoT event category; an IoT discovery category; and an IoT descriptor category.

### CROSS REFERENCE TO RELATED APPLICATIONS

This application claims the benefit of U.S. Patent Application 61/766,482, filed on Feb. 19, 2013, the entire contents of which are hereby incorporated by reference herein.

### FIELD OF INVENTION

This application is in the field of wireless communications.

### BACKGROUND

The World Wide Web has changed the way people communicate with each other and the way business is conducted. It lies at the heart of a revolution which is currently transforming the developed world towards a knowledge economy, and more broadly speaking, to a knowledge society. This development has also changed the way we think of computers. Originally computers were used for computing numerical calculations. Currently their predominant use is information processing, typical applications being data bases, text processing, and games.

In the near term, the present “Internet of PCs” may move towards an “Internet of Things” in which 50 to 100 billion devices may be connected to the Internet by 2020. Some projections indicate that in the same year, the number of mobile machine sessions may be 30 times higher than the number of mobile person sessions. If one considers not only machine-to-machine communications, but communications among all kinds of IoT Things, then the potential number of IoT Things to be connected to the Internet may rise to 100,000 billion.

### SUMMARY

A method and apparatus for communication between multiple entities in an Internet of Things (IoT) are described herein. The method comprises receiving a first information wherein the first information comprises a first instance of a category of information, wherein the first instance comprises a field which relates to a second instance of a category of information, and wherein the first instance and second instance are each selected from the group consisting of an IoT content category; an IoT context category; an IoT policy category; an IoT decision category; an IoT event category; an IoT discovery category; and an IoT descriptor category.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is an example RDF graph view of a node-arc-node link;

FIG. 3 is an example of the information flowing in the IoT systems;

FIG. 4 is an example of the ETSI M2M <contentInstance> resource structure;

FIG. 5 is an example of a knowledge hierarchy in the context of IoT;

FIG. 6 is an example RDF graph view of IoT content;

FIG. 7 is an example RDF graph view of IoT context;

FIG. 8 is an example RDF graph view of IoT policy;

FIG. 9 is an example RDF graph view of IoT decision;

FIG. 10 is an example RDF graph view of IoT event;

FIG. 11 is an example RDF graph view of IoT discovery;

FIG. 12 is an example RDF graph view of IoT descriptor;

FIG. 13 is an example of IoT information classes and class hierarchy;

FIG. 14 is an example of the information class hierarchy in RDF/XML;

FIG. 15 is an example of IoT content related properties;

FIG. 16 is an example of property descriptions of the IoTContent schema;

FIG. 17 is an example of the relationship between an IoT Content and other information categories;

FIG. 18 is an example of the relationship between an IoT Context and other information categories;

FIG. 19 is an example of the relationship between IoT policy and other information categories;

FIG. 20 is an example of the relationship between IoT decision and other information categories;

FIG. 21 is an example of the relation between IoT event and other information categories;

FIG. 22 is an example of the relationship between IoT discovery and other information categories;

FIG. 23 is an example of the relationship between IoT descriptor and other information categories;

FIG. 24 is an example of a temperatureReading type;

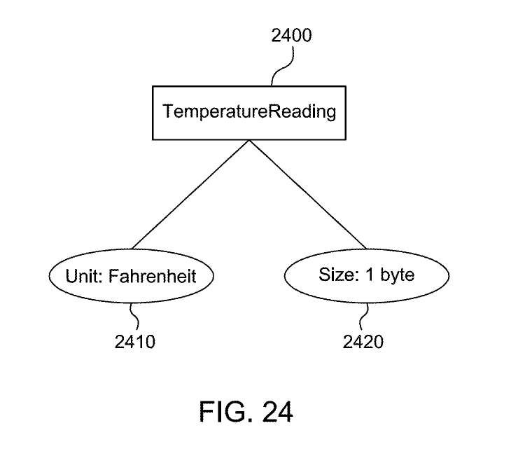

FIG. 25 is an example of information validation; and

FIG. 26 is an example of distributed data storage.

### DETAILED DESCRIPTION

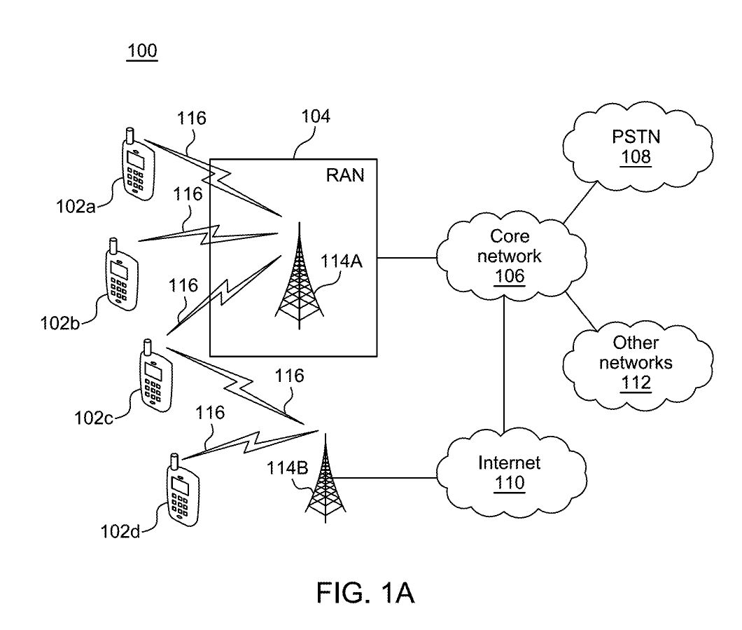

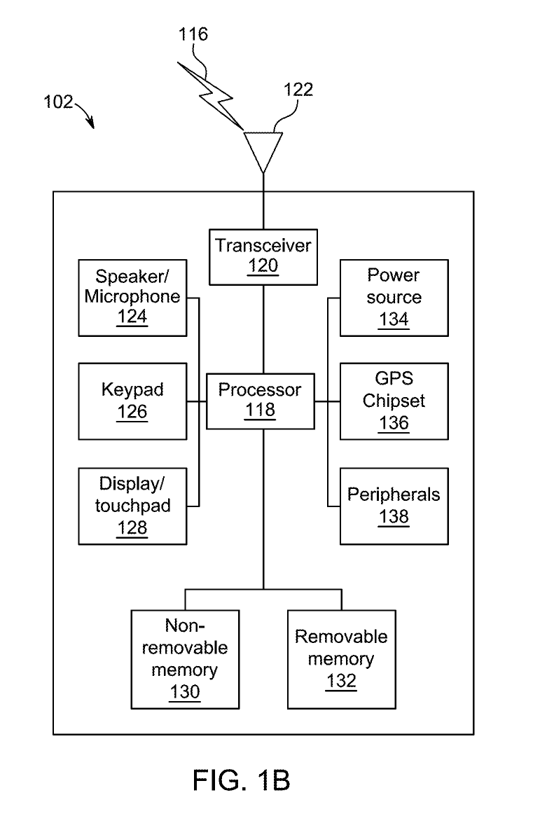

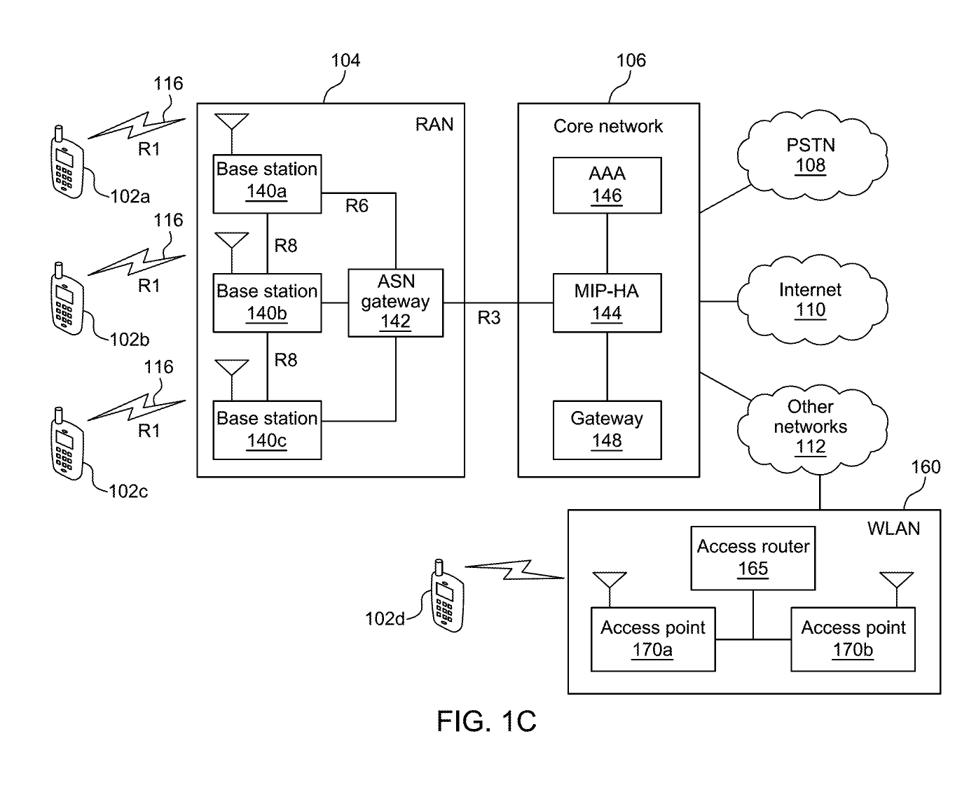

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1C, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 100c.

As shown in FIG. 1C, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 1C, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Other network 112 may further be connected to an IEEE 802.11 based wireless local area network (WLAN) 160. The WLAN 160 may include an access router 165. The access router may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a is in wireless communication over an air interface with WTRU 102d.

An Internet of Things (IoT) may include a diverse set of applications in various domains, such as system status monitoring, green operations in aerospace and aviation; automatic energy metering/home automation/wireless monitoring in intelligent buildings; personal area networks/monitoring of parameters, positioning, real time location in medical technology, healthcare; wellness, mobility, monitoring of an aging population in independent living; retail, logistics, supply chain management; manufacturing, product lifecycle management; environment monitoring; people and goods transportation; agriculture and breeding; media, entertainment and ticketing; safety, security and privacy; food traceability; recycling, and the like. IoT may connect everyday things for a smarter tomorrow.

IoT is an integrated part of Future Internet and may be defined as a dynamic global network infrastructure with self configuring capabilities based on standard and interoperable communication protocols, where physical and virtual “things” have identities, physical attributes, and virtual personalities and use intelligent interfaces, and are seamlessly integrated into the information network.

IoT systems may have highly diverse characteristics with massive heterogeneity as described herein.

In a physical environment, there may be input to and output/feedback from the physical environment. Physical IoT Things may move and interact with their surroundings including with other IoT Things. Such interactions may be spontaneous and events may be generated automatically. The number of IoT Things may have features which differ in size, resource, mobility, capability, connectivity, automation, deployment, lifetime, and the like.

In communications/networks, the communication networks for connecting IoT Things to the Internet may be heterogeneous in different dimensions such as communication technologies, network size, network topology, network coverage, and the like. A wireless sensor network (WSN) topology may be one-hop or multi-hop, and have a linear, star, tree, or mesh topology, for example. With regard to network coverage, physical IoT Things may be sparsely or densely deployed and may generate greater or lesser degrees of redundancy.

For traffic to and from a physical environment, physical IoT Things may generate data streams which may be event-driven, query-driven, or periodical in nature. There may be an uncertainty in the readings or raw sensory data from physical IoT Things. Some IoT Things, such as distributed cameras, may generate high-speed data streams, while other IoT Things may generate extremely low data rate streams. The data flow generated from most IoT Things is real-time data flow, which may vary in different time scale. There may be anycast, multicast, broadcast, and convergecast traffic modes.

For services, raw sensory data or readings may be interpreted with respect to physical environments, such as using situation/context-awareness, in order to provide semantics services. Some services may be time sensitive. For example, the actions for controlling physical environments may need to be performed over IoT Things in real-time fashion. A physical IoT Thing may provide multiple types of services or multiple IoT Things may collaborate or be grouped together to provide a service.

In order to satisfy various requirements of the above IoT applications, the future IoT may need a new architecture solution, which differs from the existing architectures such as ETSI M2M architecture, IoT-A, iCore, BUTLER, and the like. The SMART C6-Enabled IoT Architecture proposed by InterDigital may address the challenging requirements of future IoT, by supporting scalability, semantics, manageability, adaptation, reliability and sustainability, and trustworthiness while overcoming drawbacks in existing M2M/IoT architectures.

A Resource Description Framework (RDF) may include a framework for representing information in the Web. RDF may include a data-model. The basic building block of RDF may be an object-property-value triple, called a statement. RDF has been given a syntax in XML.

The fundamental concepts of RDF may include resources, properties, and statements. A resource may be thought of as an object, or a “thing” to talk about. For example, resources may be authors, books, publishers, places, people, hotels, rooms, search queries, and the like. Every resource has a Universal Resource Identifier (URI). A URI may be a Unified Resource Locator (URL), or Web address, or some other kind of unique identifier. An identifier may not necessarily enable access to a resource. URI schemes have not only been defined for web-locations, but also for such diverse objects as telephone numbers, ISBN numbers, and geographic locations.

Properties may include special kinds of resources, and may describe relations between resources, for example, “written by”, “age”, “title”, and the like. Properties in RDF may also be identified by URIs (and in practice by URLs).

Statements may assert the properties of resources. A statement may include an object-attribute-value triple, which includes a resource, a property, and a value. A value may include either resources, or literals. Literals may be atomic values or strings.

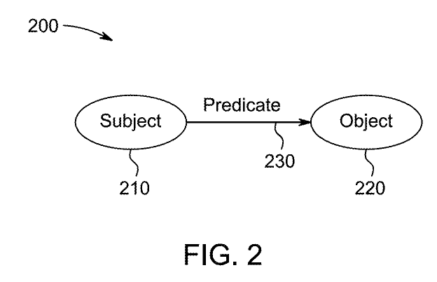

The underlying structure of any expression in RDF may be a collection of triples, each consisting of a subject, a predicate and an object. A set of such triples may be called an RDF graph. FIG. 2 is an example of a node-arc-node link in an RDF graph, and illustrates a node and directed-arc diagram 200 in which each triple is represented as a node-arc-node link. The set of nodes of an RDF graph may include the set of subjects and objects of triples in the graph.

Each triple may represent a statement of a relationship between the things denoted by the nodes that it links. Each triple may have three parts: a subject (also called a resource), an object (also called a value), and a predicate (also called a property) that denotes a relationship. In the node and directed arc diagram 200, the subject is represented by a node 210, the object is represented by a node 220, and the predicate is represented by arc 230.

An RDF may be domain-independent, in which no assumptions about a particular domain of use may be made. It is up to the users to define their own terminology in a schema language called RDF Schema (RDFS). RDFS may define the vocabulary used in RDF data models. In RDFS a vocabulary may be defined, which properties apply to which kinds of objects and what values they may take may be specified, and relationships between objects may be described.

The core classes defined by W3C are rdfs:Resource, the class of all resources; rdfs:Class, the class of all classes; rdfs:Literal, the class of all literals (strings); rdf:Property, the class of all properties; and rdf:Statement, the class of all reified statements.

The core properties defined by W3C are rdf:type, rdfs:subClassOf, rdfs:subPropertyOf, rdfs:domain, rdfs:range. rdf:type may relate a resource to its class. The resource may be declared to be an instance of that class. rdfs:subClassOf may relate a class to one of its super-classes. All instances of a class may be instances of its super-class. rdfs:subPropertyOf may relate a property to one of its super-properties. rdfs:domain may specify the domain of a property P, or specified subjects of the property in the triple. rdfs:range may specify the range of a property P. The class of those resources that may appear as values in a triple with predicate P.

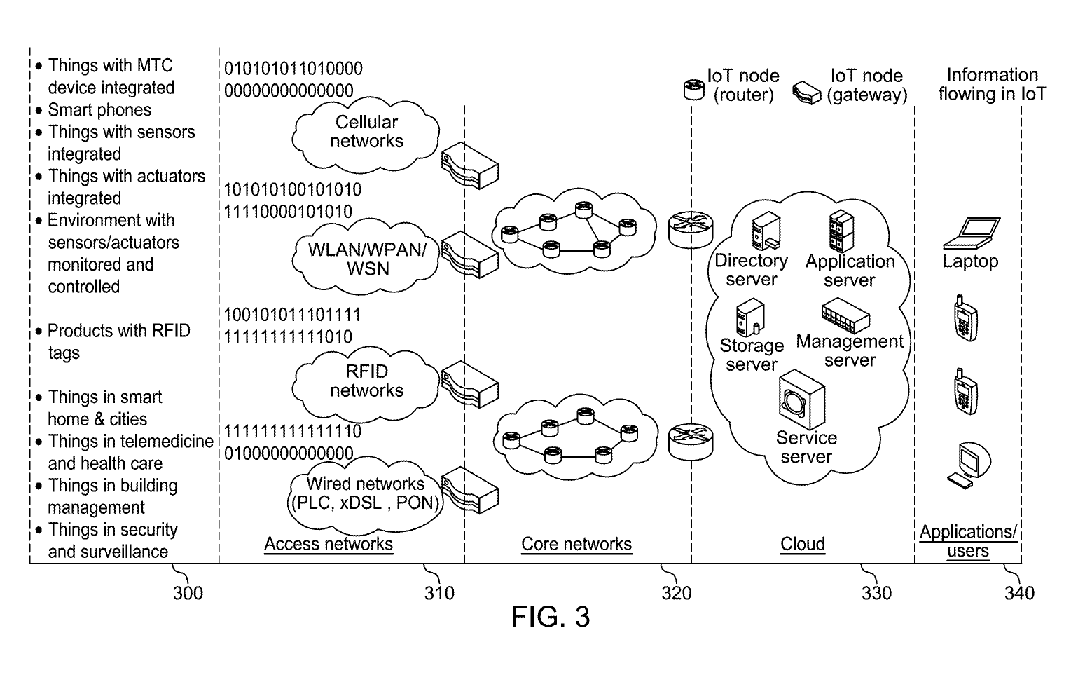

FIG. 3 is an example of the information flow in IoT systems. Information may be generated by or stored in things 300, which may include things with integrated MTC devices, smart phones, things with integrated sensors, things with integrated actuators, environments monitored and/or controlled by sensors and/or actuators, things with RFID tags, things in smart homes or cities, things in telemedicine and health care, things in building management, things in security and surveillance, and the like. Information may also be generated by or stored in nodes in access networks 310, routers and servers in core networks 320 and the cloud 330, and applications and users 340. Nodes in the access networks 310 may connect physical things to the Internet. Examples of access networks 310 are cellular networks, WLAN/WPAN/WSN, RFID networks, and wired networks such as PLC, Ethernet, xDSL, and PON. Usually, each access network 310 may have one or more IoT gateways acting as bridges to a Core Network 320. A Core Network 320 may include the public Internet or may include a private enterprise or operator owned network that may or may not interface to the public Internet. The cloud 330 may include a shared pool of configurable computing resources, for example, information, storage, applications, and services, as well as directory and management resources. As a result, there may be diverse information existing in IoT systems and flowing from one IoT Entity to another IoT Entity, from one IoT Service to another IoT Service, and/or from one protocol layer to another protocol layer.

Most of the information in today's IoT architectures may only be suitable for human consumption. Apart from the existing links which establish connections between documents, the main obstacle for providing better support in the IoT may be that, at present, the meaning of the information in IoT is not machine interpretable. The information generated and published by one IoT Entity may not be understandable by other entities due to the lack of a universal information model for the IoT systems, which may be used by machines to parse the bits in the data information. Further, the capabilities of current IoT architectures for interpreting information and extracting useful meaning and knowledge for users may be very limited. For example, in the current ETSI M2M System, an abstraction layer is provided to hide the heterogeneity of M2M access networks and to provide a middleware service layer for use by M2M applications. The Service Capability Layer (SCL) is handling data containers without any knowledge of the data contained.

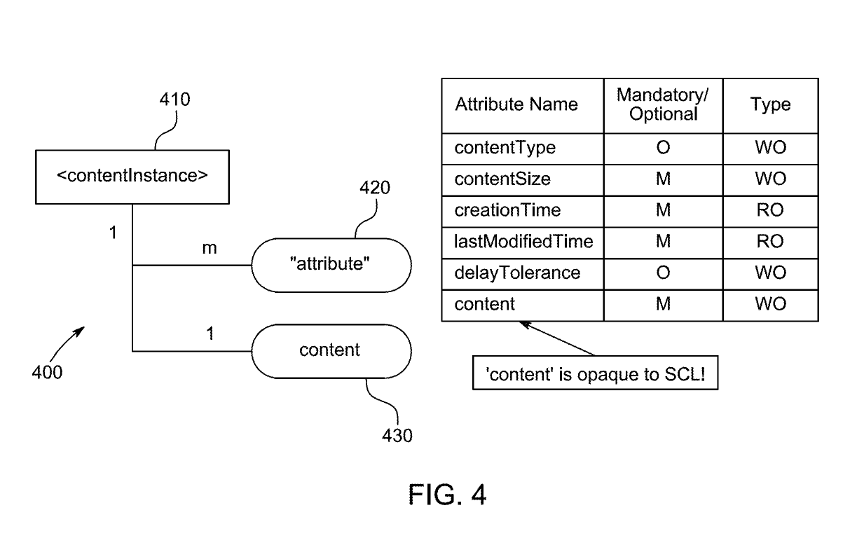

FIG. 4 is an example of a ETSI M2M <contentInstance> resource structure 400. The <contentInstance> resource 410 may contain a content attribute 420 that is opaque to the M2M platform and therefore the SCL may be unable to interpret or process the content data 430. It may not provide enough information to allow any SCL to interpret the structure of the content, for example, number of fields, ordering of fields, data types used for each field, and the like, such that the SCL may parse and understand the content. As an example, a temperature sensor device may transmit the sensed temperature reading in raw data to the attached M2M Gateway, the gateway SCL (GSCL) may not able to interpret the information, such as whether the temperature reading is in Celsius or Fahrenheit, the operations allowed on the data and the like. An information model for the content may be needed for the SCL to be able to interpret the content.

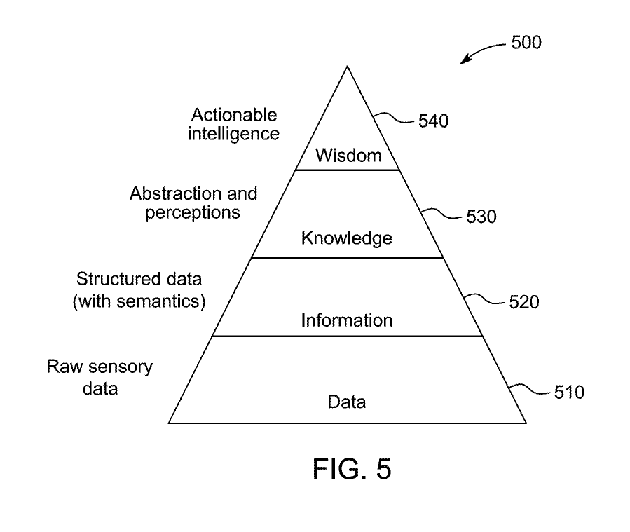

FIG. 5 is an example of a knowledge hierarchy 500 in the context of IoT. A knowledge hierarchy as shown in FIG. 5 may be desired in the context of IoT, but with less human involvement and more machine-automation. The Data layer 510 may refer to large amount of data produced by the IoT resources and devices. The Information layer 520 may help create structured and machine-readable information from the raw data of various forms to enhance interoperability. However humans and high-level applications and services often may require not only the information acquired from the Information layer 520, but high-level abstractions and perceptions (Knowledge 530) that provide human and machine-understandable meanings and insights from the underlying data. The high-level abstractions and perceptions may then be transformed to actionable intelligence (Wisdom 540) with the domain and background knowledge to exploit the full potential of IoT and create end-to-end solutions.

While the existing IoT architectures, such as ETSI M2M, may open many opportunities, they may have a number of limitations in achieving the desired knowledge hierarchy as shown in FIG. 5.

In ETSI M2M architecture, common-place vertically integrated, but isolated M2M applications may now be replaced by M2M applications which are re-using a common data transport, however they may still be vertically isolated from each other. The devices and applications may need to agree beforehand on a common definition of the exchanged containers as well as on the contained data. This may make re-use of M2M data across different applications difficult.

The context awareness may be very limited. Currently only primary context such as location and time may be supported. There may be no generic context information model that allows context to be universally interpreted, understood, and leveraged.

The cognition capability may be limited due to the lack of policy enforcement and interpretation. Currently it may only support a few policies for store and forwarding.

Event generation may be limited and event interpretation may not be supported. When an event happens, the current IoT architectures may have no generic model for describing the event so that it may be efficiently published, or broadcast with a unified understanding of the event.

The information discovery may not be efficient or robust. There may be no support for caching and reusing discovery responses. A discovery response made by one entity might not be reused even if the same discovery query is also made by other entities because the current IoT architectures may not have a generic model for discovery response messages.

The IoT Entities, IoT Services, IoT Capabilities and IoT Applications may not have generic descriptors to facilitate efficient discovery and request of the information, services, applications, and the like, that are contained in them.

The current IoT architectures may not facilitate modeling of relationships between different pieces IoT information. As a result, such information relationships may not be machine-interpretable and collaboration capabilities may be very limited.

The existing general purpose languages for representing information, such as RDF, may not make assumptions about any particular application domain, nor may they define the semantics of any domain. The terminology may need to be defined in the corresponding vocabulary description language such as RDFS. RDFS may construct the RDFS classes, associated properties and utility properties built on the limited vocabulary of RDF. Current standard RDFS may lack of the schema for interpreting the various kinds of information in the IoT in a horizontal and standard way.

In order to overcome the limitations described above, the data information transmitted in IoT may need both semantics and a level of abstraction such that the information may be categorized into different types which have common and standardized formats (metadata, units, and the like). Physical entities that are sensed and acted upon, (for example, appliances, people, cars, rooms of a building, or more generally self-contained subsystems of a larger system that makes up the target environment) may need to be modeled with a level of abstraction allowing an IoT system to treat them as generic entities that are intrinsic to the environment and not tied to a specific IoT application.

Information in the future IoT may be envisioned as self-describing and understandable to both people and devices such as computers, smart phones, and the like. In order to achieve this, a formal and logical information model may be proposed. The information model may also serve as an information view of the SMART C6-Enabled IoT Architecture, which may include the cognition-centric C6 fundamental capabilities for the future IoT.

In the proposed information model, IoT information may be categorized into seven baseline categories: IoT Content, IoT Context, IoT Policy, IoT Decision, IoT Event, IoT Discovery, and IoT Descriptor. The seven baseline categories may be extensible. It is expected that more categories may be added to these seven baseline categories as more IoT use cases evolve. Most importantly, standardized formats for those categories may be proposed, such that the information may be easily machine-processable and universally machine-interpretable. Semantics and metadata of the IoT information may be embedded in the proposed formats. In addition, the different types of information categories may have certain relationships and/or dependencies among them, which may be described herein.

IoT Content may be any textual, visual or aural information in the IoT. An extensible IoT Content model may be proposed which may facilitate various content manipulations. In the proposed IoT Content model, content may not be opaque to applications in existing IoT systems, such as may be the case in the ETSI M2M architecture, and content awareness may be achieved universally.

A field in IoT Content model may be defined to indicate the type of content, which may add additional knowledge of the content, because the content may embrace all the attributes defined for the particular type. Any value that is put in this field may be a sub-category of the IoT Content. By using the proposed field, those attributes that are specific and generic to the sub-category of the IoT content may be re-used for those contents that belong to it. In this way, the size of the metadata of the content may be reduced, which may be important for resource constrained devices in IoT. A piece of IoT content may be derived/composed from other piece of IoT content, and fields may be defined to trace such relationships. A field in IoT Content model may be defined to keep track of the popularity of the IoT content which may be important knowledge for cache replacement, information recommendation, information discovery, and the like. A field in IoT Content model may be defined to record where the IoT content may be located. This field may be used for content location resolution, content discovery and content retrieval. These fields may also apply to IoT Context, IoT Event, IoT Discovery, and IoT Descriptor categories.

IoT Context may include any information that may be used to characterize the situation of an entity. A flexible IoT Context model may be proposed which may enable different context operations and context-awareness. With the proposed IoT Context model, the context awareness may no longer be limited to primary context, such as location and time. All kinds of the context may be interpreted and understood by any people or devices with the appropriate access rights.

A field in the IoT Context model may be defined to include all the logic that the publisher of the context may need to deduce the context. This field may be important to validate the context if it is appropriately deduced. This field may include a link referring to a policy or some other information element that the context reasoning resides in.

IoT Policy may include the information describing a principle or rule to guide decisions and achieve rational outcomes. An IoT policy model may be proposed which facilitates the Cognition Capability to incorporate and interpret policies for smart decision making.

A field in IoT Policy model may be defined to point out the reason why an issuer enforces the policy. This field may be important for other people or devices to understand this policy. A field in IoT Policy model may be defined to describe the objects that the policy affects, and this field may be used by the policy executer to identify the impacted parties. Two separate fields in the IoT Policy model may be proposed to indicate the main bodies of the policy. As a result, the representation of the policy may be embedded in those two fields. A field may be proposed to be included when the policy needs to consult other policies to appropriately set up the conditions and decisions of the policy.

IoT Decision may be made by the Cognition capability to give demands or instructions for taking actions. An interpretable IoT Decision model may be proposed which may enable the IoT Decision to be easily understandable and the following actions to be accurately taken.

A field in the IoT Decision model may be proposed to outline why the issuer makes the decision and what is the desired outcome when recipient takes the action based on the decision. This field may be important for other people or devices to understand the decision. Fields in the IoT Decision model may be proposed to describe the triggering factors of the decision, what actions may need to be taken, who may receive this decision and take the actions, and when the actions may be taken by the recipient. The representation of the decision may be embedded in those four fields. A field in the IoT Decision model may be proposed to describe the objects the decision affects after the actions in the decision are taken by the recipient.

IoT Event may refer to such things as an observable occurrence, phenomenon, extraordinary occurrence, and the like. An IoT Event model may be proposed which may allow for universal interpretation of the event, and may enable broadcasting and advertising of the event.

A field in the IoT Event model may be proposed to describe the objects that the event affects or involves. Fields in the IoT Event model may be proposed to describe the location, start time and duration of the event.

IoT Discovery may contain the result of a discovery query. An IoT Discovery model may be proposed which may allow the nodes caching IoT Discovery able to interpret, broadcast, aggregate, compose and decompose it. The proposed IoT Discovery model may make the caching of it meaningful and the cached copy reusable.

Fields in the IoT Discovery model may be proposed to indicate the information identifier and the information category at which the discovery is aimed. Fields in the IoT Discovery model may be proposed to describe the discovery process. The fields may indicate that this discovery information is replied by the replier to the requestor's query made at a certain time and location, with certain search key words. Those fields may be needed for comparison when the discovery information is cached by any intermediate nodes such that when there is the same discovery query, the discovery information may be reused.

IoT Descriptor may describe the attributes of an IoT Entity, IoT Service, IoT Capability or IoT Application. IoT Entity, IoT Service, IoT Capability or IoT Application may be operable in IoT. In order to be able to discover, address and operate on an IoT Entity, IoT Service, IoT Capability or IoT Application, it may need to have the descriptor to describe the attributes of it. IoT Entity, IoT Service, IoT Capability or IoT Application descriptor may be viewed as one class of IoT information.

Fields in the IoT Descriptor model may be proposed to indicate the ID and the type of the IoT Entity, IoT Service, IoT Capability or IoT Application that the descriptor is about. In the IoT Descriptor model it may be proposed to communicate all the information contained in the IoT Entity, IoT Service, IoT Capability or IoT Application that the descriptor concerns. These fields may facilitate information discovery on the IoT Entity, IoT Service, IoT Capability or IoT Application.

The IoT information model, including IoT Content model, IoT Context model, IoT Policy model, IoT Decision model, IoT Event model, IoT Discovery Model, IoT Descriptor model and more, may need to be adopted for any IoT Thing or IoT Entity to interpret and understand the information acquired from the physical world. An IoT Thing or IoT Entity, such as those illustrated in FIG. 3, may contain various combinations of the information categories. Through the proposed information model, information in IoT may be self-describing in a way that is understandable by other people and devices other than the information creator or publisher. It may also allow instant data, described using the model, to be validated and reasoned over to infer logical conclusions not explicitly in the original data. Information on the future IoT may be linked or connected in the sense that the information may make sense when it is put together with other data from the same or related domains. The relationships among information may enable the exposing, sharing, and connecting pieces of data, information, and knowledge in the future IoT.

The proposed information model may be mapped to and integrated into any metadata data model, such as RDF, and described by any vocabulary description language, such as RDFS. A mapping and integration scheme for the proposed information model to RDF/RDFS may be provided. The fields defined in the information model may be easily described by RDFS and may serve as complementary and standard schemas that are currently missing in RDFS for the IoT domain.

IoT Content may be any textual, visual or aural information in the IoT. The defined IoT Content model and formats may facilitate various content manipulations. IoT content may have the following formats: contentID, name, type, creationTime, lifetime, producer, size, operation, derivedFrom, derivesTo, accessRight, retrievalNum, location, and representation.

For contentID, each content may have a unique identifier that is addressable.

Name may provide the name of the content.

Type may indicate the type of the content, such as numeric data, video, binary executable program, and the like. Since content may be considered as storable in electronic devices such as computers, generally it may have one extension, such as .bin, .mov, .mp3, and the like. The type may include further granularity by extending the existing types. For example, the type may be TemperatureReading which may extend the type of Floating-Point, which on the other hand may extend numeric data type. In the description of the class TemperatureReading, the unit of the data may be defined, such as Fahrenheit. The types may be defined and published by the producer of the content to enable easy understanding of the content. Meanwhile, when the types are published, they may also have unique identifiers, which may be addressed and used by other IoT Entities, IoT Services, IoT Capabilities, and/or IoT Applications. XML Schema may predefine a large range of data types, for example, Boolean, Integer, Floating-point, Time, Date, and the like. As a result, the type may be standardized, which may be predefined, or user-defined and which may be represented by and stored under its URI. On the other hand, the type may also be included as part of the content itself.

CreationTime may indicate when the content was originally created. In the case of a content being cached, it may indicate the time when the content is cached. In the case of a content being aggregated from other content, it may indicate the time when the content is aggregated and generated.

Lifetime may indicate the duration that the content is considered to be valid.

Producer may denote the original creator of the content. A content instance may be generated by more than one producer. For example, the content may be an average temperature aggregated from many temperature readings sensed by corresponding sensors, which may be included in Producer.

Size may denote the size of the content, for example in bytes.

For operation, in the SMART C6-Enabled IoT architecture, it may be proposed that the operations which may be carried out on a content instance are no longer limited to creation, retrieval, update, and delete. A content instance may be published, cached, transformed, composed/decomposed, adapted, aggregated, and the like.

DerivedFrom may include a list of content, from which the content is derived/composed/decomposed from. As an example, a video content may be composed from the clips of the video.

DerivesTo may include the list of content, to which the current content derives.

AccessRight may indicate the access right of the content, including but not limited to: Write, Read, Delete, Cache (WDRC). The accessRight defined herein (including the one defined for other IoT information categories) may not be limited to WDRC as stated above, but may depend on the operations that are allowed as defined for this information category. For example, the accessRight may be Transform, Adapt, or the like. On the other hand, the metadata itself may have different access rights for different audiences. For example, the creationTime and producer may only be accessible to a particular group of entities, instead of being open to the public.

RetrievalNum may keep statistics for the number of times that the content instance is being retrieved by other IoT Entities, IoT Services, IoT Capabilities, and/or IoT Applications. This value may change over time and is a local statistic kept individually by the content provider and content caching locations.

Location may record possible locations of the content. This list may change over time and may be kept individually by the content provider, content caching locations and content routers.

Representation may contain a representation of the content or a link pointing to the representation of the content.

Some content may share the same values of properties, but the content representation itself may have a much smaller size compared to the additional information of the content. As a result, it may be proposed that the formats of the content may be separated into individual content and sharable content. For example, contentID, Name, Size and Representation may be unique to each of the content, which may be viewed as individual content. On the other hand, a group of content may share the same type, producer, operation, and the like, which may be viewed as sharable content. As a result, it may be proposed that additional content information may be co-located with the content in one representation, or located separately in different representations. Either representation of the content may have a link pointing to the pieces of additional information of the content, or the pieces of additional information may have links pointing to the content, or there may be pointers in both directions. This proposal may also apply to other information categories.

Context may include any information that may be used to characterize the situation of an entity. An entity may be a person, place, or object that is considered relevant to an interaction between a user and an application, including the user and applications themselves. IoT context may have the following format: contentID, name, type, lifetime, publisher, creationTime, rule, derivedFrom, derivesTo, operation, accessRight, retrievalNum, location, and representation.

For contextID, each context may have a unique identifier that is addressable.

Name may provide the name of the context.

Type may indicate the type of the context. In the SMART C6-Enabled architecture, all kinds of context may be involved, which may be divided into, but not limited to, physical context, technical context, personal context, social context, and operation context. The physical context may include location, time, temperature, light intensity, nearby persons, and the like. The technical context may include network status (bandwidth, latency, error rate, traffic load, link quality, network coverage, and the like), device status (input and out capabilities, memory, power, software support), available services, service specification, service input and output, and the like. The personal context may include address, phone number, preferences, schedule, service preferences, and the like. The social context may include list of friends, groups or teams to which the user belong, and the like. The operational context may include roles, activities, to-do-items, shopping-list, and the like. The types of context may be defined and published by the publisher of the context to enable easy understanding of the context. Context types may be grouped into primary and secondary types. The primary contexts may mainly be about location, time and entity. The primary context may be used as an index into other secondary context data.

Lifetime may indicate the duration that the context is considered to be valid.

Publisher may denote the original publisher of the context, who may annotate or reason the context at the Abstraction or/and Reasoning layer from the data collected by the collection layer.

CreationTime may indicate when the context information was originally created. In the case of a context being cached, it may indicate the time when the context is cached. In the case of a context being aggregated from other contexts, it may indicate the time when the context is aggregated and generated.

Rule may include logic that the publisher uses to obtain the context. If the context does not require any reasoning, but states the facts about entities, such as user profile, device remaining power, the rule may be left to be empty. The rule may be enforced in deriving or reasoning higher context from lower context and data. The higher context may be directly used by context-aware applications to take actions. The rule may also include a link to a policy informational element.

DerivedFrom may include a list of data or/and lower context, from which the context is derived. As an example, two temperature sensors may sense raw data from the physical world. The lower context that may be generated from the data may be the average temperature in the area. The average temperature may be computed by averaging the two temperature sensor readings. The higher level context that may be derived from the data may be that the neighborhood is under a high temperature alert. The derivedFrom field may include the data URIs of the temperature sensor readings of the two temperature sensors.

DerivesTo may include a list of contexts, to which the current context derives.

For operation in the SMART C6-Enabled IoT architecture, it may be proposed that operations which may be carried out on a context may no longer be limited to creation, retrieval, update, delete. A context may be cached, abstracted, adapted, and the like.

AccessRight may indicate the access right of the context. The context may be public or private. A public context may be provided to the public, including for example, weather information, time, and the like, which may be easily obtained by everyone and may overlap between applications in similar situations. The private context may be sensitive information, possibly user-related, such as exact position, preferences, behavior patterns, and the like. The private context may need special protection and require security, privacy and safety methods. The accessRight defined in this disclosure (including the one defined for other IoT information categories) may not be limited to public and private stated above, but may depend on the operations that are allowed for this information category. For example, the accessRight may include Cache, Adapt, and the like.

RetrievalNum may keep statistics of the number of times that the context is retrieved or used by other entities. This value may change over time and may be a local statistic kept individually by the context publisher and/or context caching locations.

Location may record possible locations of the context. This list may change over time and may be kept individually by a context publisher and/or context caching locations.

Representation may contain a representation of the context or the link pointing to the representation of the context.

Similar to the classification of the fields defined for IoT Content, the attributes of IoT Context may also be divided into individual and sharable attributes. The fields contextID, Name and Representation may be regarded as having unique values to an IoT context. Other fields may have the same values for different IoT contexts.

The policy information in the SMART C6-Enabled IoT architecture may be described as a principle or rule to guide decisions and achieve rational outcomes. The policies may be fed to a Cognition Capability for making decisions. The IoT policy may have the following format: policyID, name, issuer, creationTime, purpose, scope, effectiveTime, type, condition, decision, reference, operation, accessRight, retrivalNum, and location.

For policyID, each policy may have a unique identifier that is addressable.

Name may provide the name of the policy.

Issuer may denote the issuer of the policy, who may enforce such policy to certain IoT information elements, IoT Entities, IoT Services, and the like.

CreationTime may indicate when the policy information was originally created.

Purpose may outline why the issuer is enforcing the policy, and what may be the desired effect or outcome of the policy. For example, there may be an IoT Entity sensing the local temperature, which may be requested by any application. For example, a Gateway proxying on behalf of an IoT Entity may issue a policy such that when the query rate reaches certain threshold, it may decide to virtualize the IoT Entity in the Gateway. The purpose of such policy may be to minimize the power consumption of the IoT Entity, for example.

Scope may describe who the policy affects. In the above example, the scope of the policy may be the IoT Entity and the Gateway.

EffectiveTime may indicate when the policy comes into force and for how long the policy remains in force.

Type may indicate the type of the policy. A policy in the SMART C6-Enabled IoT architecture may be a universally adopted policy or a customized policy. A universally adopted policy may include a rule that every IoT entity recognizes and follows, and may be deployed in a centralized policy database of a Cognition capability. A customized policy may have scope and applicability, and for different IoT entities and Services, the customized policy may vary. The policies may be categorized based on their type of related activities and operations. The activities and operations in the SMART C6-Enabled IoT architecture may be various, such as routing, caching, virtualization, subscription, and the like.

Condition may contain the condition or a list of conditions in atomic formulas separated by commas or other characters. Conditions may be referred to as the body of the policy. The commas in the policy body may be read conjunctively. In the above example, the condition of the policy may be that the gateway observes that the query rate of the temperature reading data hosted on the IoT Entity reaches a certain threshold.

Decision may contain the decision or a list of decisions that shall be made if all the conditions are true. In the above example, the decision of the policy may be to virtualize the IoT Entity in the Gateway.

Reference may indicate other policy(s) that is referenced by the issuer to set up this policy. In the above example, the threshold may be determined by referencing another policy, which may describe the rule on how to choose the appropriate threshold of the query rate based on the remaining power of the IoT entity.

For operation in the SMART C6-Enabled IoT architecture, it may be proposed that the operations may be carried out on a policy are no longer limited to creation, retrieval, update, delete. A policy may be published, cached, composed/decomposed, adapted, and the like.

AccessRight may indicate the access right of the policy, including but not limited to: read, write, delete, and cache.

RetrievalNum may keep statistics about the number of times that the policy is retrieved by other entities. This value may change over time and may be a local statistic that is kept individually by the policy issuer and/or policy caching locations.

Location may record possible locations of the policy. This list may change over time and may be kept individually by the policy issuer and/or policy caching locations.

Similar to the classification of the fields defined for IoT Content, the attributes of IoT Policy may also be divided into individual attributes and sharable attributes. Fields policyID, Name, Condition and Decision may be regarded as having values unique to an IoT policy. Other fields may have the same values for different IoT policies.

An IoT decision may be made by the Cognition capability to give demands or instruction on taking actions. The decision making process may be regarded as a continuous process integrated with interaction from the environment, and a problem solving activity which may be terminated when a satisfactory solution is reached. The decision may be made by picking an action from among alternative actions. The alternative actions may be evaluated against all the objectives. An IoT decision may have the following format: decisionID, name, issuer, creationTime, purpose, trigger, executor, recipient, scope, executionTime, action, type, operation, and accessRight.

For decisionID, each decision may have a unique identifier that is addressable.

Name may provide the name of the decision.

Issuer may denote the issuer of the decision, which may indicate actions that need to be taken by itself, or may involve other IoT entities or information elements.

CreationTime may indicate when the decision information was originally created.

Purpose may outline why the issuer makes the decision, and what is the desired effect or outcome after the decision is taken by the recipient. For example, an IoT Entity may decide that it is willing to collaborate with the neighboring IoT entities in caching content. The purpose of this decision may be to improve the storage efficiency such that there are no duplicate copies of the same content stored in the neighborhood.

Trigger may describe the triggering factors of the decision. The triggering factors may include an event or a link to an event informational element, content change, context change, or the like. As an example, the trigger of the decision that two IoT Entities in the same neighborhood will collaborate with each other may be the fact that they learn each other's storage capability for caching content. As another example, after the two IoT Entities decide to collaborate with each other in caching content, it may make the decision to delete the copy of the same cached content from its own storage. The trigger of such decision may be that the issuer finds a duplicate copy of the same content in another IoT Entity's storage.

Executor may indicate who is going to carry out the actions included in the decision. In the above example, when the IoT Entity collaborates with the neighboring nodes, it may find out that there is a duplicate copy of a content in another IoT Entity. The two IoT Entities may negotiate with each other and may make a decision to delete one of the copies. The decision may also involve who is going to take this action, which may be shown in the Recipient field.

Recipient may indicate who is going to be notified of the decision other than the executor of the decision. In the above example, the executor of the decision may be one of the IoT Entities who is going to delete its local copy of the content. The other IoT Entity may be notified of the decision as well, which may be indicated in the Recipient field.

Scope may describe who or what the decision affects. The scope of the decision may include any information element, IoT entities, IoT Service, or the like. In the above example, the scope of the policy may be the copy of the content stored in the issuer's storage. The issuer may delete this copy of the content from the memory.

ExecutionTime may indicate when the recipient of the decision needs to take the action after it receives the decision. In most cases, the executionTime may be immediate as in the above example. But there may be cases where is decided that an air conditioner in the house should be turned off in 2 hours, for example.

Action may indicate the action the recipient of the decision needs to carry out after it receives the decision. In the above example, the action may be to delete one copy of the content from the recipient's local storage.

Type may indicate the type of the decision. The decisions may be categorized based on their type of related activities and operations. The activities and operations in the SMART C6-Enabled IoT architecture may be various, such as routing, caching, virtualization, subscription, and the like.

For Operation in the SMART C6-Enabled IoT architecture, it may be proposed that the operations carried out on a decision no longer be limited to creation, retrieval, update, delete. A decision may be published, cached, adapted, and the like.

AccessRight may indicate the access right of the decision, including but not limited to: read, write, and cache.

Similar to the classification of the fields defined for IoT Content, the attributes of IoT Decision may also be divided into individual attributes and sharable attributes. Fields decisionID, Name, Trigger, Action, Recipient, executionTime may be regarded as having values unique to each IoT decision. Other fields may have the same values for different IoT decisions.

IoT events may refer to many things such as an observable occurrence, phenomenon, extraordinary occurrence, and the like. An IoT event has the following format: eventID, name, scope, type, creationTime, publisher, occurringLocation, occurringTime, duration, derivedFrom, derivesTo, operation, accessRight, retrievalNum, location, and representation.

For eventID, each event may have a unique identifier that is addressable.

Name may provide the name of the event.

Scope may describe who or what the event affects or involves. The scope of the event may be any information element, IoT entities, IoT Service, or the like. As an example, in the application of fleet management, the events may include that vehicle A just passed through a toll gate B at time C. The scope of the event may include vehicle A.

Type may indicate the type of the event. The decisions may be divided into types by the related applications. The applications in the SMART C6-Enabled IoT architecture may be various, such as the fleet management in the above example.

CreationTime may indicate when the event information was originally created.

Publisher may denote who might announce the event. In the above example the Publisher of the event may be either vehicle A or the toll gate B.

OccurringLocation may denote where the event happens. In the above example, the occurringLocation may be the location of the toll gate B.

OccurringTime may denote when the event happens. In the above example, the occurringTime may be the time C.

Duration may indicate how long the event lasts. The duration may be estimated, planned or instantaneous, and the like. In the above example, the event may be instantaneous since vehicle A may not stop at the toll gate B. Some event duration may be planned however. For example, a conference event may be planned for a period of a week. Some event duration may be estimated. For example, there may be a flood at a bridge. How long the flood might last may be estimated by different parameters.

DerivedFrom may include a list of data and/or low level context and/or high level context, from which the event is derived. In the above example, the event may be derived from the data collected by an RFID device attached to the vehicle.

DerivesTo may include a list of events, to which the current event derives.

For operation in the SMART C6-Enabled IoT architecture, it may be proposed that operations carried out on an event no longer be limited to creation, retrieval, update, delete. A context can be cached, abstracted, and the like.

AccessRight may indicate the access right of the event. The event may be public or private. A public event may be announced to the public, for example, a flooding event. A private event may be announced only to a certain group of entities.

RetrievalNum may keep statistics of the number of times that the event is being retrieved or used by other entities. This value may change over time and may be a local statistic that is kept individually by the event publisher, event caching places.

Location may record possible locations of the event. This list may change over time and may be kept individually by the event publisher, and/or event caching locations.

Representation may contain a value of the event.

Similar to the classification of the fields defined for IoT Content, the attributes of IoT Event may also be divided into individual and sharable fields. Fields eventID, Name, occurringLocation, occurringTime and Duration may be regarded as having values unique to an IoT event. Other fields may have the same values for different IoT events.

An IoT discovery may contain the result of a discovery query, which may have the following format and may be used to facilitate the caching of information and benefit other requestors opportunistically: discoveryID, creationTime, querylnfoID, queryInfoType, requestor, queryTime, queryLocation, searchKeys, lifetime, replier, size, operation, derivedFrom, derivesTo, accessRight, retrievalNum, location, and representation.

For discoveryID, each discovery may have a unique identifier that is addressable.

CreationTime may indicate when the discovery information was originally created. In the case of a discovery being cached, it may indicate the time when the discovery is cached.

QueryInfoID may indicate the ID of the information the discovery is aimed at. This field may be left empty if the requestor is not querying a particular piece of information with a known identifier.

QueryInfoType may indicate the type of the information the discovery is aimed at. The type may be content, context, policy, decision, event or descriptor.

Requestor may denote the identity of the entity which made this discovery request, which may be a user, an application, a Service, or the like.

QueryTime may denote when the discovery query was made.

QueryLocation may denote where the discovery query was made.

SearchKeys may denote the key words with which the discovery query was made. The key words may be fields in each information type. For example, each type of information may have a location field. When the location key word was specified, the discovery query may return the potential locations of the information being queried.

Lifetime may indicate a duration that the discovery information is considered to be valid.

Replier may denote the entity which replies to the discovery query. The replier may be the original destination of the discovery request message or some intermediate node that may capture this query and return with its local cached result.

Size may denote the size of the discovery information, for example in bytes.

For operation, in the SMART C6-Enabled IoT architecture, it may be proposed that operations carried out on a discovery are no longer limited to creation, retrieval, update, delete. A discovery may be published, cached, composed/decomposed, or the like.

For derivedFrom, the discovery information may be generated from other discovery information. For example, if a content is divided into two pieces of content, the discovery information of the content may be generated from the discovery information of the two pieces of content. If the discovery information is related to some queried information which is independent and is not a part of other information, this field may be left empty.

DerivesTo may include a list of discoveries, to which the current discovery generates.

AccessRight may indicate the access right of the discovery, including but not limited to: read, write, and cache.

RetrievalNum may keep statistics of the number of times that the discovery is being retrieved by other entities. This value may change over time and may be a local statistic kept individually by the content provider, and/or content caching locations.

Location may record possible locations of the discovery. This list may change over time and may be kept individually by the content provider, content caching locations and content routers.

Representation may contain the discovery result in IDs, which can be information matched to the searchKeys or locations of the queried information. The location may be represented for example as IP addresses (a type of ID).

Similar to the classification of the fields defined for IoT Content, the attributes of IoT Discovery may also be divided into individual attributes and sharable attributes. Fields discoveryID, queryInfoID, queryInfoType, Requestor, queryTime, queryLocation, searchKeys, Replier may be regarded as having values unique to an IoT discovery. Other fields may have the same values for different IoT discovery information.

An IoT Descriptor may contain information about a system element in the IoT architecture, among which IoT Entity, IoT Service, IoT Capability and IoT Application are considered for the proposed SMART C6-Enabled IoT Architecture. The descriptor may be designed to describe an IoT Entity, IoT Service, IoT Capability, and IoT Application, which may then be able to be discovered, addressed and operated on. The format of the IoT Descriptor is as follows: descriptorID, creationTime, lifetime, descriptorTargetID, descriptorTargetType, size, listOfApplication, listOfService, listOfCapability, listOfFunctionality, listOfContent, listOfContext, listOfPolicy, listOfDecision, listOfEvent, listOfDiscovery, listOfDescriptor, listOfInterface, operation, derivedFrom, derivesTo, accessRight, retrievalNum, and location.

For descriptorID, each descriptor may have a unique identifier that is addressable.

CreationTime may indicate when the descriptor information was originally created.

Lifetime may indicate a duration that the descriptor information is considered to be valid.

DescriptorTargetID may indicate the ID of the IoT Entity, IoT Service, IoT Capability and IoT Application that the descriptor is about.

DescriptorTargetType may indicate the type of the IoT Entity, IoT Service, IoT Capability and IoT Application.

Size may denote the size of the descriptor information, for example in bytes.

ListOfApplication may contain an overview list of IoT applications that are associated with this descriptor.

ListOfService may contain an overview list of IoT services that are associated with this descriptor.

ListOfCapability may contain an overview list of IoT capabilities that are associated with this descriptor.

ListOfFunctionality may contain the overview list of IoT functionalities that are associated with this descriptor.

ListOfContent may contain an overview list of content that are stored or generated by the IoT Entity, Service and Application.

ListOfContext may contain an overview list of context that are stored or generated by the IoT Entity, Service and Application.

ListOfPolicy may contain an overview list of policies that are stored or generated by the IoT Entity, Service and Application.

ListOfDecision may contain an overview list of decisions that are stored or made by the IoT Entity, Service and Application.

ListOfEvent may contain an overview list of events that are stored or generated by the IoT Entity, Service and Application.

ListOfDiscovery may contain an overview list of discoveries that are stored or generated the IoT Entity, Service and Application.

ListOfDescriptor may contain an overview list of descriptors that are stored or generated the IoT Entity, Service and Application.

ListOfInterface may contain a list of interfaces that are provided by the IoT Entity, Service and Application.

For operation in the SMART C6-Enabled IoT architecture, it may be proposed that operations carried out on a descriptor are no longer limited to creation, retrieval, update, delete. A descriptor may be published, cached, composed/decomposed, and the like.

For derivedFrom, the descriptor information may be generated from other descriptor information. For example, an IoT Entity may have applications and Services, whose descriptor may be generated from the descriptors of those applications and Services that are residing in the IoT Entity.

DerivesTo may include a list of descriptors, to which the current descriptor generates.

AccessRight may indicate the access right of the descriptor, including but not limited to: read, write, and cache.

RetrievalNum may keep statistics of the number of times that the descriptor is retrieved by other entities. This value may change over time and may be a local statistic kept individually by the descriptor provider and descriptor caching locations.

Location may record potential locations of the descriptor. This list may change over time and may be kept individually by the descriptor provider and descriptor caching locations.

Similar to the classification of the fields defined for IoT Content, the attributes of IoT Descriptor may also be divided into individual attributes and sharable attributes. Fields descriptorID, descriptorTargetID, descriptorTargetType, Size, listOfApplication, listOfService, listOfCapability, listOfFunctionality, listOfContent, listOfContext, listOfPolicy, listOfDecision, listOfEvent, listOfDiscovery, listOfDescriptor, listOfInterface may be regarded as having values unique to an IoT policy. Other fields may have the same values for different IoT descriptors.

The proposed information model may be mapped to and integrated into any metadata data model, such as RDF, and described by any vocabulary description language, such as RDFS.

A mapping and integration scheme for the proposed information model to RDF/RDFS is described herein. The information categories may be converted into classes, which are subclasses of IoT Information. The fields in each IoT information category may be illustrated by RDF graphs, which may be mapped to the predicates (properties) presented in arcs in the RDF graph. The instances from each information category may be mapped to subjects in RDF. The values of the fields in each information category may be mapped to objects in RDF. Those classes and properties may serve as complementary and standard schemas that may be missing in RDFS for the IoT domain.

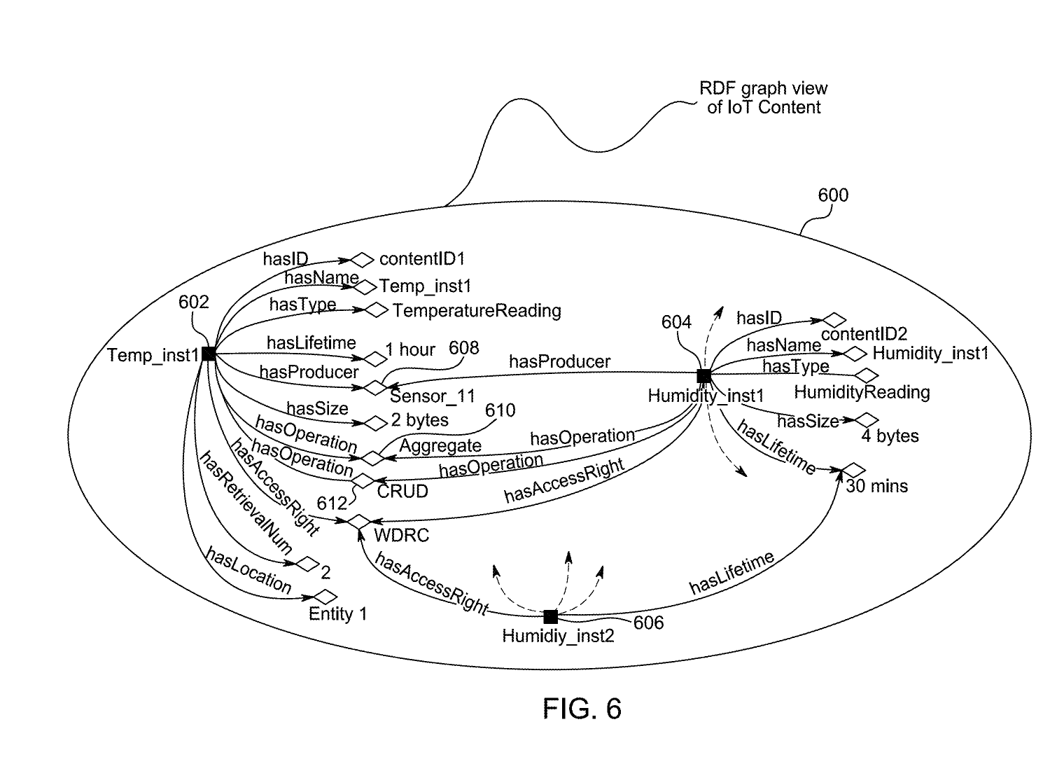

FIG. 6 is an example RDF graph view 600 of IoT content. FIG. 6 illustrates an RDF graph view of three content instances: Temp_inst1 602, Humidity_inst1 604, Humidity_inst2 606. FIG. 6 shows that RDF may be one potential data model to represent the semantics of the data in IoT, but the proposed information view of IoT may not be limited to RDF, and is flexible to any other existing and future data model. Temp_inst1 602, Humidity_inst1 604, Humidity_inst2 606 may be instances of the class IoT Content. The formats of IoT Content defined herein may be mapped to properties in RDF and RDFS, which may include hasID, hasName, hasType, hasCreationTime, hasLifetime, hasProducer, hasSize, hasOperation, derivedFrom, derivesTo, hasAccessRight, hasRetrievalNum, and hasLocation. The content may share the same property values with each other, which may be indicated by the links between them. As an example, the content Temp_inst1 602 and Humidity_inst1 604 may have the same producer of Sensor 11 608, and have the same operations of Aggregate 610, and CRUD 612 (create, read, update and delete). Other example property/value pairs for Temp_inst1 are hasID/contentID1, hasName/Temp_inst1, hasType/TemperatureReading, hasLifetime/1 hour, hasSize/2 bytes, hasAccessRight/WDRC (also shared with Humidity_inst1 604 and Humidity_inst2 606), hasretrievealNum/2 and hasLocat8ion/Entity1. Other example property/value pairs for Humidity_inst1 are hasID/contentID2, hasName/Humidity_inst1, hasType/HumidityReading, hasSize/4 bytes, hasAccessRight/WDRC (also shared with Humidity_inst2 606 and Temp_inst1 602) and hasLifetime/30 mins (shared with Humidity_inst2 606). Other example property/value pairs for Humidity_inst2 are hasLifetime/30 mins (shared with Humidity_inst1 604) and hasAccessRight/WDRC (shared with Humidity_inst1 604 and Temp_inst1 602).

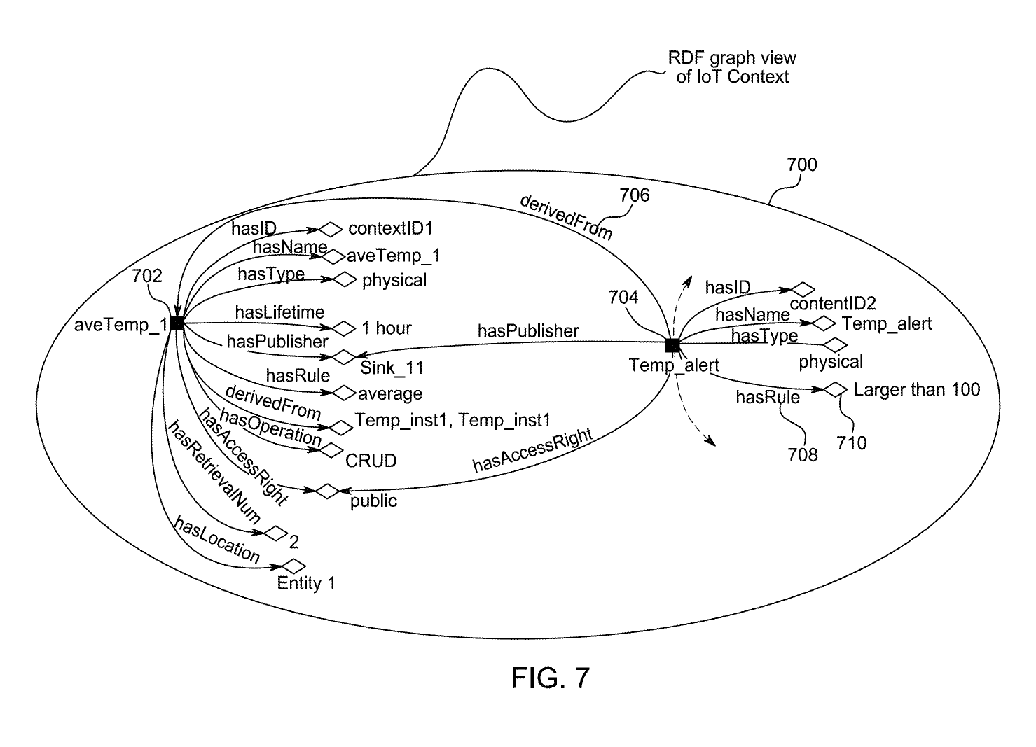

FIG. 7 is an example RDF graph view 700 of IoT context. FIG. 7 illustrates an RDF graph view of two contexts: aveTemp_1 702, Temp_Alert 704, which may be instances of the class Context. The format of IoT Context defined herein may be mapped to properties in RDF and RDFS, which may include hasID, hasName, hasType, hasLifetime, hasPublisher, hasCreationTime, hasRule, derivedFrom, derivesTo, hasOperation, hasAccessRight, hasRetrievalNum, and hasLocation. The contexts 702, 704 may have relationships between each other which may be indicated by the links between them. In this example, Temp_Alert 702 may be derived from aveTemp_1 704, as shown by predicate derivedFrom 706 with the rule 708 that if aveTemp_1 704 reaches some threshold 710 (e.g. 100F), the area is under the high temperature alert. Other example property/value pairs for aveTemp1 702 include hasID/contextID1, hasName/aveTemp_1, hasType/physical, hasLifetime/1 hour, hasPublisher/Sink_11 (shared with Temp_alert 704), hasRule/average, derivedFrom/Temp_inst1, Temp_inst1, hasOperation/CRUD, hasAccessRight/public (shared with Temp_alert 704), hasRetrievealNum/2, and hasLocation/Entity 1. Other example property/value pairs for Temp_alert 704 include hasPublisher/Sink_11 (shared with aveTemp_1 702), hasID/contextID2, hasName/Temp_alert, hasType/physical, hasRule/Larger than 100, and hasAccessRight/public (shared with ave_Temp_1 702).

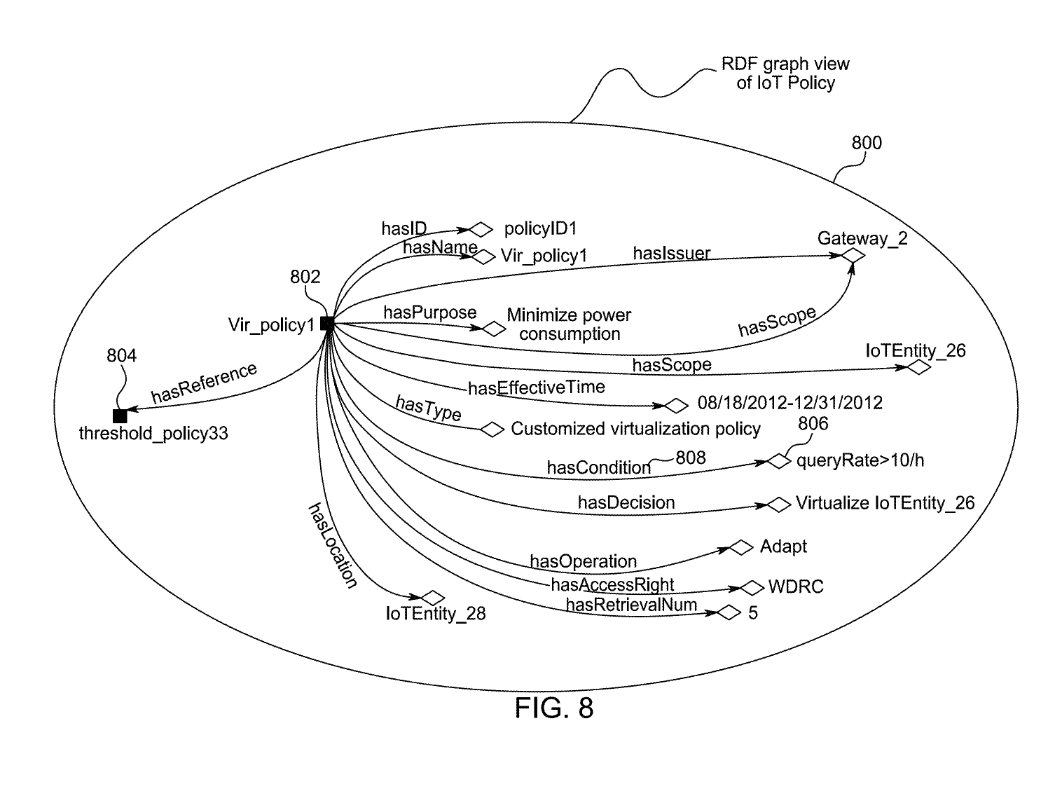

FIG. 8 is an example RDF graph view of IoT policy. FIG. 8 illustrates an RDF graph view of two policies: Vir_policy1 802, threshold_policy33 804, which may be instances of the class Policy. The format of IoT policy defined herein may be mapped to properties in RDF and RDFS, which may include hasID, hasName, hasIssuer, hasCreationTime, hasPurpose, hasScope, hasEffectiveTime, hasType, has Condition, hasDecision, hasReference, hasOperation, hasAccessRight, hasRetrievalNum, and hasLocation. The policies may have relationships between each other which may be indicated by the links between them. In this example, Vir_policy1 802 may refer to the policy threshold_policy33 804 to set the threshold 806 in its condition 808. Other example property/value pairs for Vir_policy1 include hasID/policyID1, hasName/Vir_policy1, hasPurpose/Minimize Power Consumption, hasIssuer/Gateway_2, hasScope/Gateway 2 (note that hasIssuer and hasScope map to the same value, i.e. Gateway_2), hasScope/IoTEntity_26 (note that there is more than one hasScope property), hasEffectiveTime/08/18/2012—12/31/2012, hasType/Customized virtualization policy, hasDecision/Virtualize IoTEntity_26, has Operation/Adapt, hasAccessRight/WDRC, hasRetrievalNum/5, hasLocation/IoTEntity_28, and hasReference/threshold_policy33 (note that the hasReference policy here has the instance threshold_policy33 804 as a value).

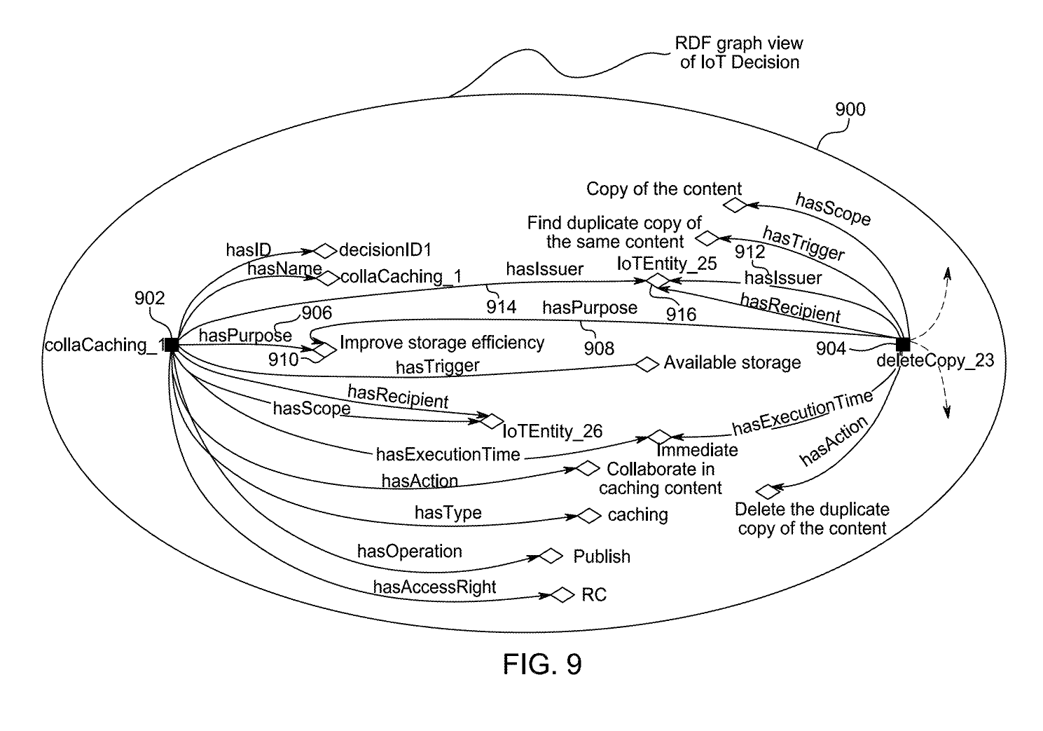

FIG. 9 is an example RDF graph 900 view of IoT decision. FIG. 9 illustrates an RDF graph view of two decisions: collaCaching_1 902, deleteCopy_23 904, which may be instances of the class Decision. The format of IoT decision defined herein may be mapped to properties in RDF and RDFS, which may include hasID, hasName, hasIssuer, hasCreationTime, hasPurpose, hasTrigger, hasExecutor, hasRecipient, hasScope, hasExecutionTime, hasAction, hasType, hasOperation, and hasAccessRight. The decisions may have relationship between each other which may be indicated by the links between them. In this example, both the decisions collaCahing_1 902 and deleteCopy_23 904 may have the same purpose 906, 908 of improving storage efficiency 910, and the same issuer 912, 914 of IoTEntity_25 916. Other example property/value pairs for collaCaching_1 902 include hasID/decisionID1, hasName/collaCaching1, hasTrigger/Available storage, hasRecipient/IoTEntity_26, hasScopedoTEntity_26 (note that the hasRecipient and hasScope properties reference the same value, i.e. IoTEntity_26), hasExecutionTime/Immediate (shared with deleteCopy_23), has Action/Collaborate in caching content, hasType/caching, hasOperation/Publish, and hasAccessRight/RC. Other example property/value pairs for deleteCopy_23 904 include hasScope/Copy of the content, hasTrigger/Find duplicate copy of the same content, hasRecipient/IoTEntiy_25 (note that the hasIssuer property of both deleteCopy_23 904 and collaCaching_1 902 each also reference this same value, i.e. IoTEntity25 916), hasExecutionTime/Immediate (shared with collaCaching_1 902), and has Action/Delete the duplicate copy of the content).

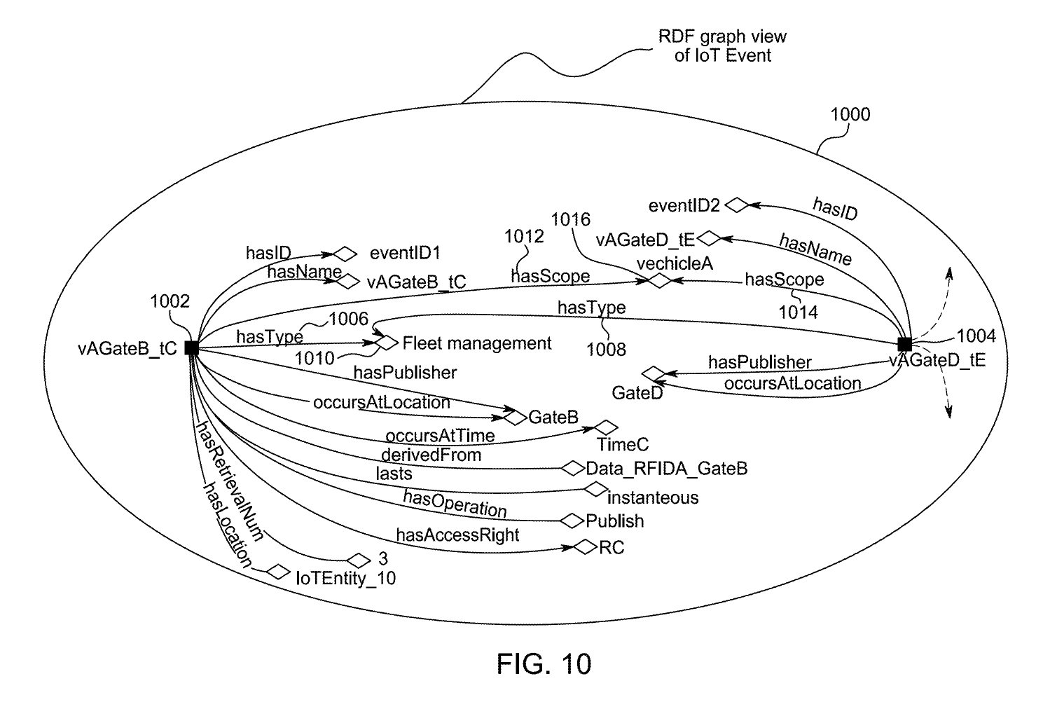

FIG. 10 is an example RDF graph 1000 view of IoT event. FIG. 10 illustrates an RDF graph view of two events: vAGateB_tC 1002, vAGateD_tE 1004, which may be instances of the class Event. The format of the IoT event defined herein may be mapped to properties in RDF and RDFS, which may include hasID, hasName, hasScope, hasType, hasCreationtime, hasPublisher, occursAtLocation, occursAtTime, lasts, derivedFrom, derivesTo, has Operation, hasAccessRight, hasRetrivalNum, and hasLocation. The events may have relationships between each other which may be indicated by the links between them. In this example, both the events vAGateB_tC 1002 and vAGateD_tE 1004 may have the same type 1006, 1008 of fleet management 1010, the same scope 1012, 1014 of vehicleA 1016. Other example property/value pairs for vAGateB_tC 1002 include hasID/eventID1, hasName/vAGateB_tC, hasPublisher/GateB, occursAtLocation/GateB (note that hasPublisher and occursAtLocation reference the same value, i.e. GateB), occursAtTime/TimeC, derivedFrom/Data_RFIDA_GateB, lasts/instantaneous, has Operation/Publish, hasAccessRight/RC, hasRetrievealNum/3, and hasLocation/IoTEntity_10. Other example property/value pairs for vAGateD_tE include hasID/eventID2, hasName/vAGateD_tE, hasPublisher/GateD, and occursAtLocation/GateD (note that hasPublisher and occursAtLocation reference the same value, i.e. GateD).

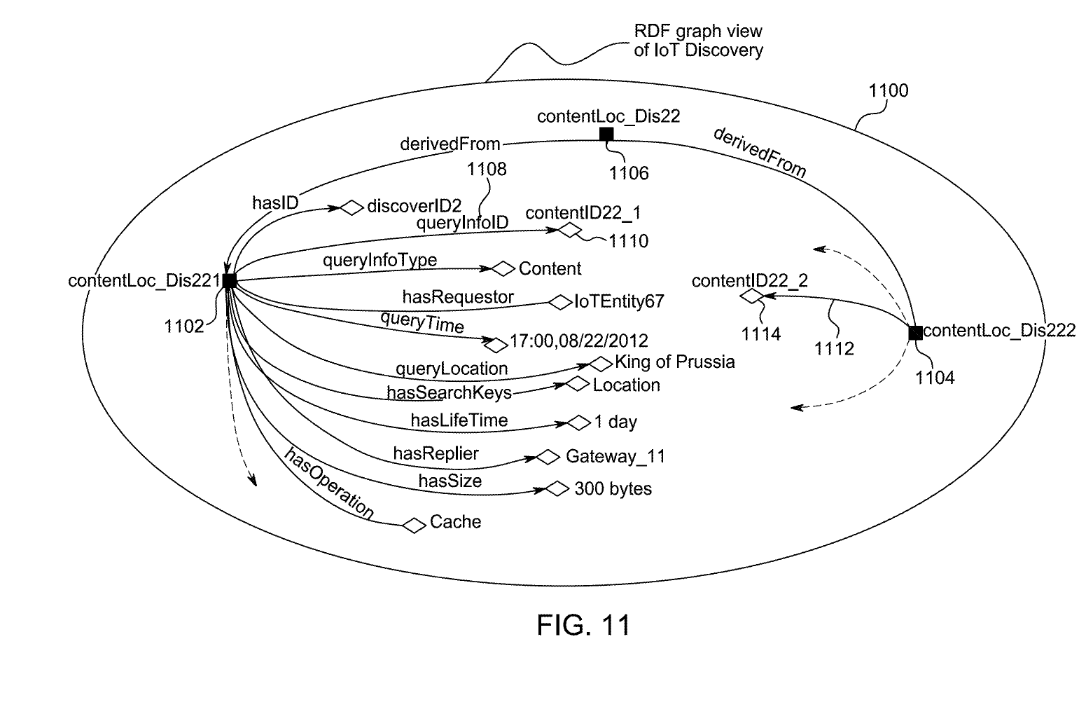

FIG. 11 is an example RDF graph 1100 view of IoT discovery. FIG. 11 illustrates an RDF graph view of three discoveries: contentLoc_Dis221 1102, contentLoc_Dis222 1104 and contentLoc_Dis22 1106, which may be instances of the class Discovery. The format of IoT Discovery defined herein may be mapped to properties in RDF and RDFS, which may include hasID, hasCreationTime, queylnfoID, queryInfoType, hasRequestor, queryTime, queryLocation, hasSearchKeys, hasLifetime, hasReplier, hasSize, hasOperation, derivedFrom, deriveTo, hasAccessRight, and hasRetrivalNum, hasLocation. The discoveries may have relationships between each other which may be indicated by the links between them. In this example, the discovery information contentLoc_Dis221 1102 may contain the potential locations (querylnfoID 1108) of the contentID22_1 1110, contentLoc_Dis222 1104 may contain the potential locations (queryInfoID 1112) of the contentID22_2 1114, contentLoc_Dis22 1106 may contain the potential locations of contentID22 (not shown). ContentID22_1 and contentID22_2 may be parts of contentID22, as a result, the discovery information may be generated from contentLoc_Dis221 and contenLoc_Dis222. Note that contentLoc_Dis22 has a property derivedFrom which references contentLoc_Dis222 1104 and another property derivedFrom which references contentLoc_Dis221 1102. Other example property/value pairs for contentLoc_Dis221 1102 include hasID/discoveryID2, queryInfoType/Content, hasRequestor/IoTEntity67, queryTime/17:00,08/22/2012, queryLocation/King of Prussia, hasSearchKeys/Location, hasLifeTime/1 day, hasReplier/Gateway_11, hasSize, 300 bytes, and hasOperation/Cache.

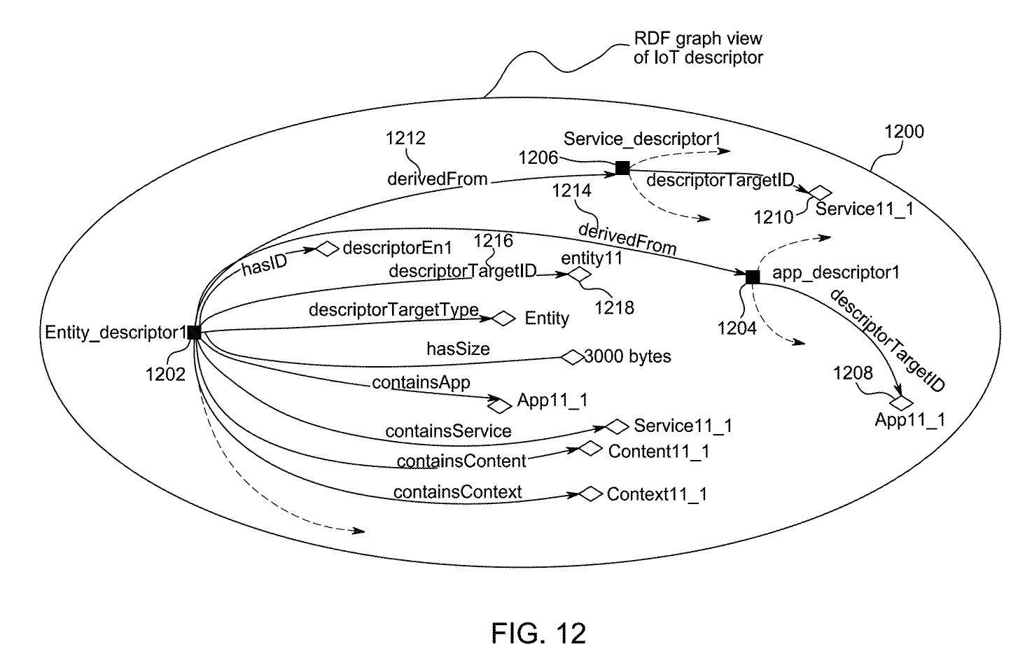

FIG. 12 is an example RDF graph 1200 view of IoT descriptor.

FIG. 12 illustrates an RDF graph view of three descriptors: Entity_descriptor1 1202, app_descriptor1 1204 and Service_descriptor1 1206, which may be instances of the class Descriptor. The format of IoT Descriptor defined herein may be mapped to properties in RDF and RDFS, which may include hasID, has CreationTime, hasLifetime, descriptorTargetID, descriptorTargetType, hasSize, containsApp, contains Service, contains Capability, containsFunctionality, contains Content, contains Context, containsPolicy, containsDecision, containsEvent, containsDiscovery, containsDescriptor, hasInterface, hasOperation, derivedFrom, derivesTo, hasAccessRight, hasRetrivalNum, and hasLocation. The descriptors may have relationships between each other which may be indicated by the links between them. In this example, the part of the descriptor information Entity descriptor 1 1202 may be generated from the descriptor of the application App11_1 1208 and the Service11_1 1210, which may be contained in the entity11 1218, following the predicates derivedFrom 1212, 1214, 1216. Other exampler property/value pairs for Entity_descriptor1 1202 include hasID/descriptorEn1, descriptorTargetType/Entity, hasSize/3000 bytes, containsApp/App11_1, containsService/Service11_1, containsContent/Content11_1, and containsContext/Context11_1.

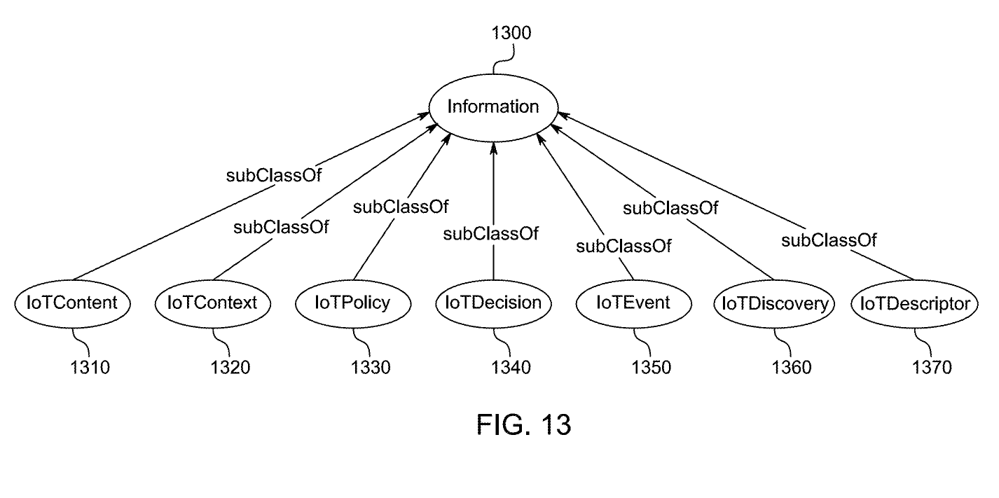

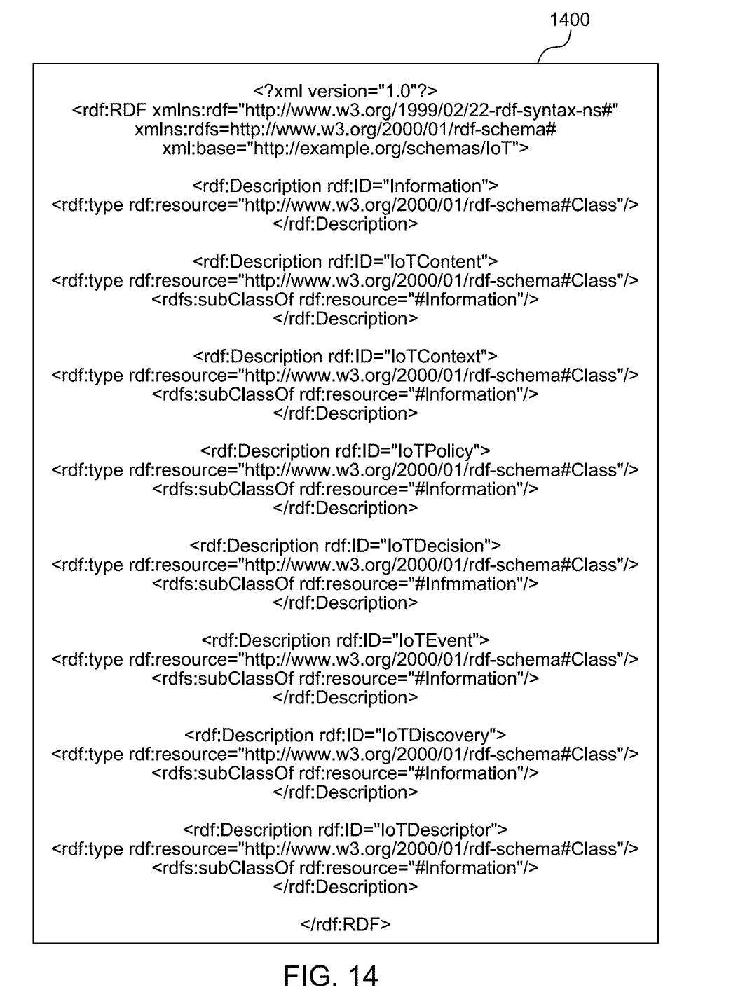

FIG. 13 is an example of IoT information classes and class hierarchy. As shown in FIG. 13, the information in the IoT domain may be categorized into 7 baseline types, which may be converted to 7 classes in RDFS: IoTContent 1310, IoTContext 1320, IoTPolicy 1330, IoTDecision 1340, IoTEvent 1350, IoTDiscovery 1360 and IoTDescriptor 1370. They may all be sub classes of the Information Class 1300. FIG. 14 is an example 1400 of this information class hierarchy set forth in RDF/XML.

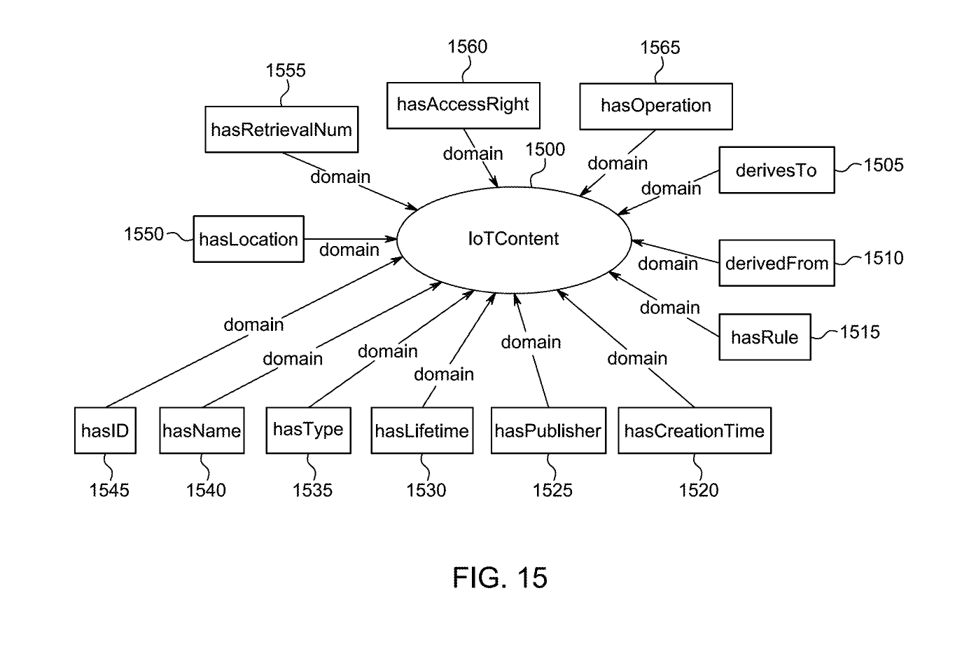

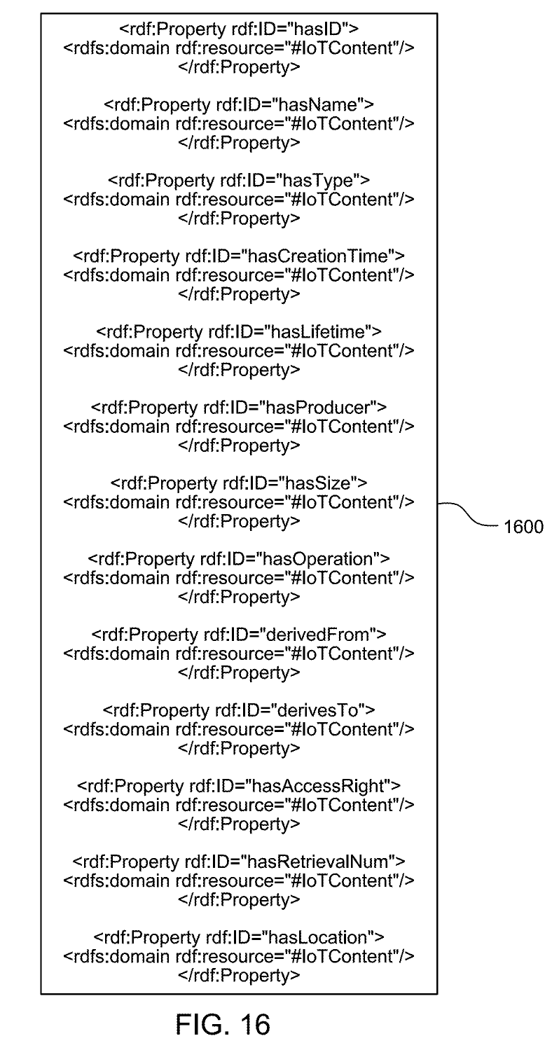

FIG. 15 illustrates an example of IoT content related properties. The fields in each category may be converted to properties in RDFS as described above. As an example, the fields in the IoT Content category 1500 may be converted to properties as illustrated in FIG. 15, i.e. derivesTo 1505, derivedFrom 1510, hasRule 1515, hasCreationTime 1520, hasPublisher 1525, hasLifetime 1530, hasType 1535, hasName 1540, hasID 1545, hasLocation 1550, hasRetrievalNum 1555, hasAccessRight 1560, and hasOperation 1565, and all the properties may have the domain of IoTContent. FIG. 16 is an example of an IoTContent schema 1600 which includes these property descriptions.

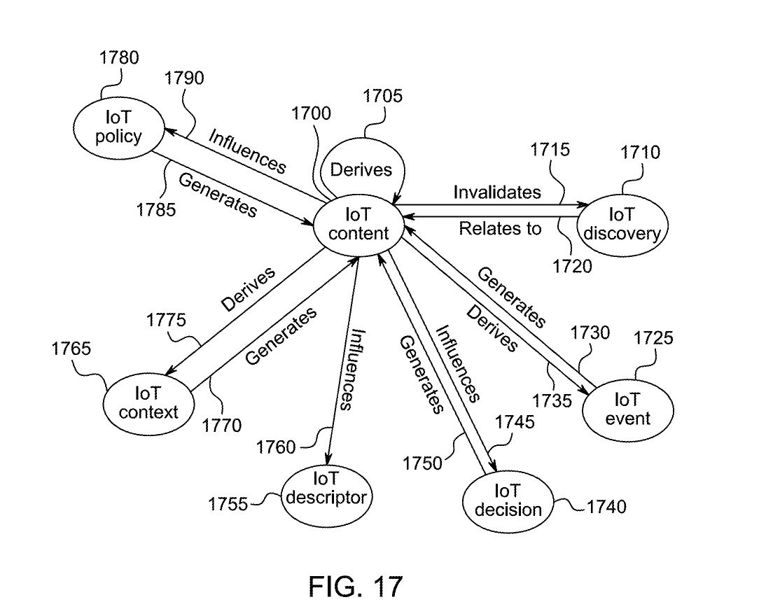

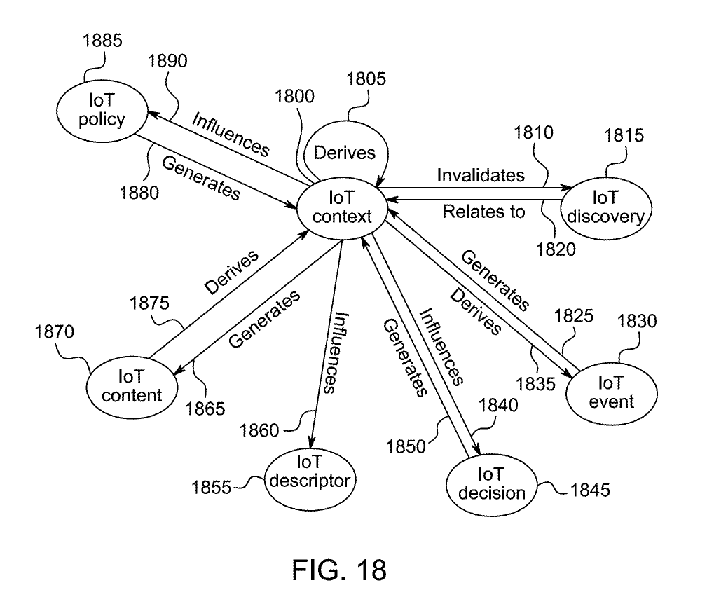

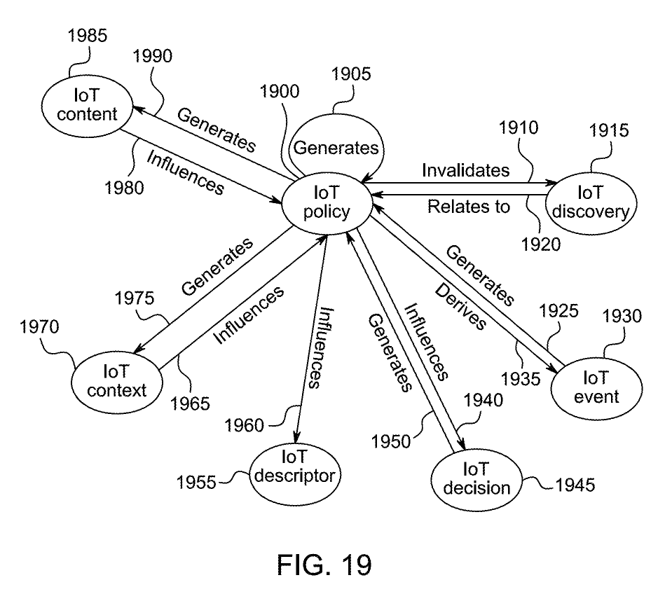

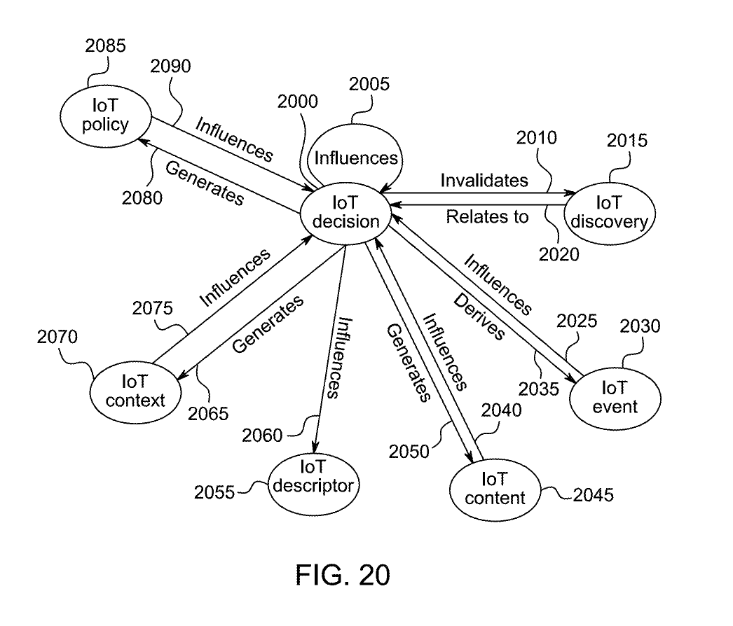

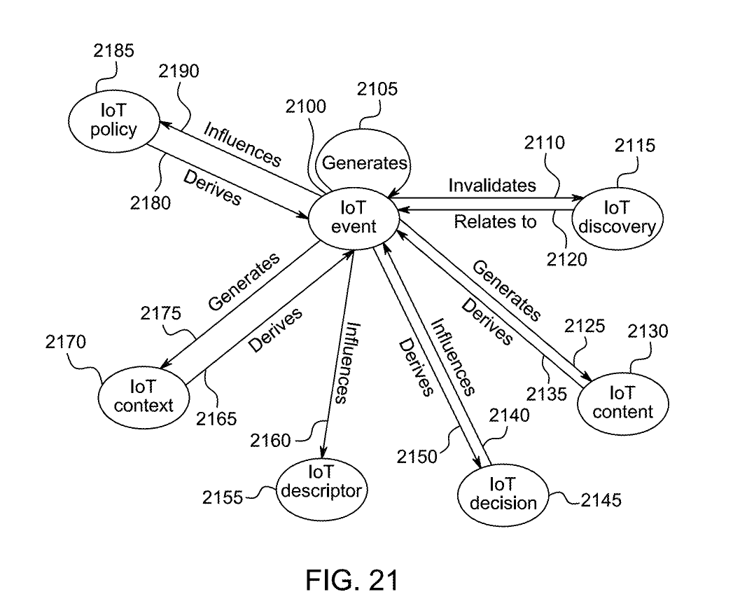

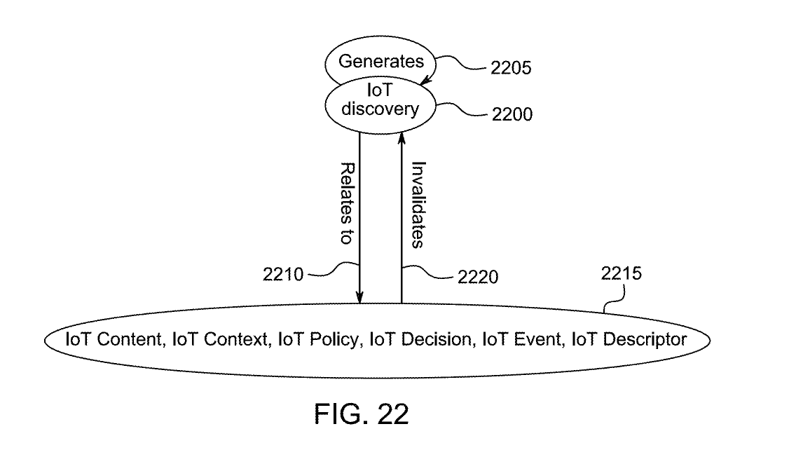

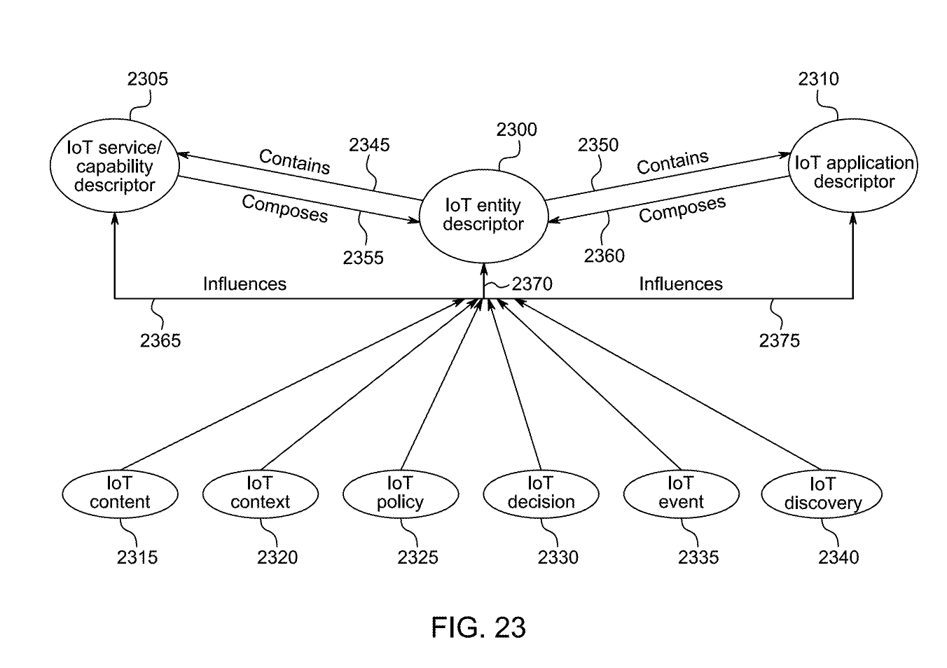

As described above, a piece of IoT information in each category may have relationships with other IoT information. The arcs may show such relationships. In other words, the fields of each category may link one information instance to another information instance. The information instances may be in the same information category or different categories. relationships among the different IoT information categories may be described. It may be shown how the fields defined in the information model link one information category to other information categories. FIG. 17, FIG. 18, FIG. 19, FIG. 20, FIG. 21, FIG. 22, and FIG. 23 illustrate example relationships among the different IoT information categories that may be relevant to an instance in IoT Content, IoT Context, IoT Policy, IoT Decision, IoT Event, IoT Discovery and IoT Descriptor respectively. The relationships shown in those figures may be extensible to more specific ones based on the characteristics of the both involved information instances, for example, types and publishers. Since the relationships are bidirectional, they may be only described once in the following but shown completely in the figures.

The following is a summary of the relationships that may be discussed for each information category. For generates, the creation, update or deletion of an information instance may originate other information instance(s). For derives, the values/content of an information instance may be acquired from the values of other information instances based on certain rules or policies. For influences, the value/content of an information instance may be dynamically adjusted by the value/content of another information instance. For relates to, the value/content of an information instance may be relevant to other information instances, such that it is subject to the change of the values of the other information instances. For invalidates, the value/content of an information instance may become invalid or useless due to the change in the values of other information instances. For composes, the value/content of an information instance may be part of the content of another information instance. For contains, the value/content of an information instance may be made up of the content of other information instances.

FIG. 17 is an example of the relationship between the IoT Content category and other information categories. IoT Content 1700, IoT Context 1765, IoT Policy 1780, IoT Decision 1740 and IoT Event 1725 may derive 1705, 1775, and generate 1785, 1750, 1730 new IoT Content 1700, which is indicated by the derivesTo/derivedFrom fields in each information instance (not shown). IoT Discovery may contain the search result of certain content, which may relate 1720 to IoT content. On the other hand, any change in the content itself, for example, its location or format, may invalidate 1715 any cached IoT discovery information. The linkage may be realized by the field queryInfoID/queryInfoType in the Discovery information (not shown). IoT Content may influence 1790, 1745, 1760 IoT Policy, IoT Decision and IoT Descriptor. The influence to the policy may be indicated in the Reference field of the policy, the influence to the decision may be indicated in the Trigger field of the decision, and influence to the descriptor may be indicated in the listOfContent field of the descriptor target (not shown). As an example, if IoT Content 1700 is stored on an IoT Entity, any modification to the IoT Content may influence 1760 the IoT Descriptor 1755 of the IoT Entity because the listOfContent field (not shown) may be changed.

FIG. 18 is an example of the relationship between the IoT Context category and other information categories. IoT Content 1870, IoT Context 1800, IoT Policy 1885, IoT Decision 1845 and IoT Event 1830 may derive 1875, 1805, 1835 and generate 1865, 1880, 1850, 1825 new IoT Context 1800, which may be indicated by the derivesTo/derivedFrom fields in both information instances (not shown). IoT Context 1800 may influence 1890, 1840, 1860 IoT Policy 1885, IoT Decision 1845 and IoT Descriptor 1855. The influence to the policy may be indicated in the Reference field of the policy, the influence to the decision may be indicated in the Trigger field of the decision, and the influence to the descriptor may be indicated in the listOfContext field of the descriptor target (not shown). As an example, if IoT Context 1800 is stored on an IoT Entity, any modification on it may influence 1860 the IoT Descriptor 1855 of the IoT Entity because the listOfContext field may be changed (not shown). IoT Context 1800 may derive 1835 an IoT Event 1830, which may be indicated by the derivesTo/derivedFrom fields in both information instances (not shown). For example, if the average temperature is higher than a certain degree, then a high temperature alert may be triggered. IoT Discovery 1815 may contain the search result of certain context, which may relate 1820 to IoT Context 1800. On the other hand, any change in the context itself, for example, its location or format, may invalidate 1810 any cached IoT discovery 1815 information. The linkage may be realized by the field queryInfoID/queryInfoType in the Discovery information (not shown).

FIG. 19 is an example of the relationship between the IoT Policy category and other information categories. An IoT Policy 1900 may be generated 1905, 1950, 1925 from another IoT Policy 1900, IoT Decision 1945, and IoT Event 1930, which may be indicated by the derivesTo/derivedFrom fields in both information instances (not shown). An IoT Policy 1900 may influence 1960 IoT Descriptor 1955. The influence 1960 to the descriptor 1955 may be indicated in the listOfPolicy field of the descriptor target. As an example, if an IoT Policy 1900 is stored on an IoT Entity, any modification on it may influence the IoT Descriptor 1955 of the IoT Entity because the listOfPolicy field (not shown) may be changed. An IoT Policy 1900 may also influence 1940 the IoT decision 1945, which may be indicated by the Trigger field (not shown) in the IoT decision 1945. An IoT Policy 1900 may derive 1935 IoT Event 1930, which may be indicated by the derivesTo/derivedFrom fields (not shown) in both information instances. For example, if IoT Policy 1905 states that if the average temperature is higher than 90 degrees, then the area may be under high temperature alert. With this IoT Policy 1905 enforced in a certain area, when the condition is satisfied, the IoT Event 1930 may be derived 1935. IoT Discovery 1915 may contain the search result of certain policy, which may be related to IoT Policy 1900. On the other hand, any change in the policy itself, for example, its location or format, may invalidate 1910 any cached IoT Discovery 1915 information. The linkage may be realized by the field queryInfoID/queryInfoType (not shown) in the IoT Discovery 1915 information.

FIG. 20 is an example of the relationship between the IoT Decision category and other information categories. An IoT Decision 2000 may be influenced 2090, 2025, 2040, 2075, 2005 by IoT Policy 2085, IoT Event 2030, IoT Content 2045, IoT Context 2070 or another IoT Decision 2000, which may be indicated by the Trigger field of the decision (not shown). IoT Decision 2000 may derive 2035 IoT Event 2030, and generate 2080, 2065, 2050 IoT Policy 2085, IoT Context 2070 and IoT Content 2045, which may be indicated by the derivesTo/derivedFrom fields in each information instance (not shown). IoT Discovery 2015 may contain the search result of a certain decision, which may be related 2020 to IoT Decision 2000. On the other hand, any change in the decision itself, for example, its location or format, may invalidate 2010 any cached IoT Discovery 2015 information. The linkage may be realized by the field queryInfoID/queryInfoType (not shown) in the IoT Discovery information 2015. An IoT Decision 2000 may influence 2060 IoT Descriptor 2055. The influence to the descriptor may be indicated in the listOfDecision field of the descriptor target (not shown). As an example, if an IoT Decision 2000 is stored on an IoT Entity, any modification to it may influence 2060 the IoT Descriptor 2055 of the IoT Entity because the listOfDecision field (not shown) may be changed.

FIG. 21 is an example of the relation between the IoT Event category and other information categories. An IoT Event 2100 may be generated 2105 from another IoT Event 2100, or derived 2135, 2165, 2180, 2150 from other information such as IoT Content 2130, IoT Context 2170, IoT Policy 2185 or IoT Decision 2145, which may be indicated by the derivesTo/derivedFrom fields (not shown) in each information instance. IoT Discovery 2115 may contain the search result of a certain event, which may be related to 2120 IoT Event 2100. On the other hand, any change in the event itself, for example, its location or format, may invalidate 2110 any cached IoT Discovery 2115 information. The linkage may be realized by the field queryInfoID/queryInfoType in the Discovery information (not shown). An IoT Event 2100 may influence 2140 IoT Descriptor 2155. The influence to the descriptor may be indicated in the listOfEvent field of the descriptor target (not shown). As an example, if an IoT Event 2100 is stored on an IoT Entity, any modification on it may influence 2160 the IoT Descriptor 2155 of the IoT Entity because the listOfEvent field (not shown) may be changed.

FIG. 22 is an example of the relationship between the IoT Discovery category and other information categories. IoT Discovery 2200 may be generated 2205 from another instance of IoT Discovery 2200, which is indicated by the derivesTo/derivedFrom fields in each information instance (not shown). IoT Discovery 2200 may contain the search result of a certain content, context, policy, decision, event or descriptor, which may be related 2210 to IoT Content, IoT Context, IoT Policy, IoT Decision, IoT Event and IoT Descriptor 2215 respectively. On the other hand, any change in the content, context, policy, decision, event and descriptor itself, for example, its location or format, may invalidate 2220 any cached IoT Discovery 2200 information. The linkage may be realized by the field queryInfoID/queryInfoType in the Discovery information (not shown).

FIG. 23 is an example of the relationship between the IoT Descriptor category and other information categories. As described above, the IoT Descriptor 2300 may include the description information for an IoT Entity, IoT Service or IoT Application. An IoT Entity may contain IoT Service 2305, IoT Application 2310, IoT Content 2315, IoT Context 2320, IoT Policy 2325, IoT Decision 2330, IoT Event 2335 and/or IoT Discovery 2340 information. An IoT Application and IoT Service may also contain 2345, 2350 IoT Content 2315, IoT Context 2320, IoT Policy 2325, IoT Decision 2330, IoT Event 2335 and/or IoT Discovery 2340 information. In other words, the IoT Service/Capability Descriptor 2305 and IoT Application Descriptor 2310 may compose 2355, 2360 the IoT Entity Descriptor 2300. Those relationships may be indicated by the descriptorTargetID/descriptorTargetType fields in the IoT Descriptors (not shown). An IoT Entity Descriptor 2300 may be generated by including the IoT Service Descriptor 2305 and IoT Application Descriptor 2310 of those IoT Services and Applications located on this IoT Entity, which may be indicated by the derivesTo/derivedFrom fields in each information instance (not shown). The fields in each IoT Descriptor 2300, 2305, 2310, such as listOfContent, listOfContext, listOfPolicy, listOfEvent, listOfDiscovery, listOfDescriptor may all be influenced 2365, 2370, 2375 by the corresponding information elements. Any operation on those information elements may change the descriptor.

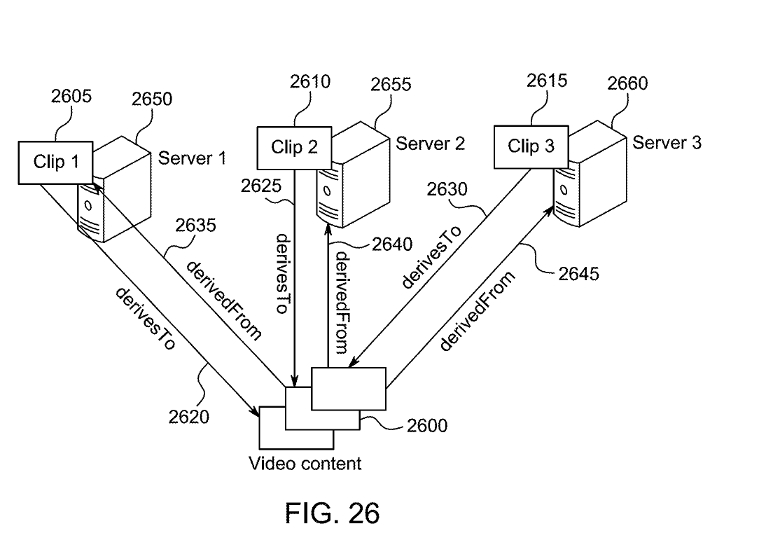

The information model proposed may enable the interpretation and understanding of the raw data by all entities with the access right. In an example, a temperature sensor device may transmit a sensed temperature reading in raw data to an attached M2M Gateway. Without the information model, the GSCL may not be able to interpret the information, such as whether the temperature reading is in Celsius or Fahrenheit, the operations allowed to the data, and the like. The information model may add the additional information about the raw data with the defined fields. For example, the type filed may associate the raw data with the temperatureReading type. FIG. 26 is an example of a temperatureReading type 2400. The temperatureReading type 2400 may indicate that all data with this type is in unit Fahrenheit (Unit) 2410, has size of one byte (Size) 2420. Operations allowed on the data may be indicated in the operation field, and may include for example, aggregate, cache, and publish.

The proposed information model with the embedded relationships between things may be used to check the validity of a piece of information.

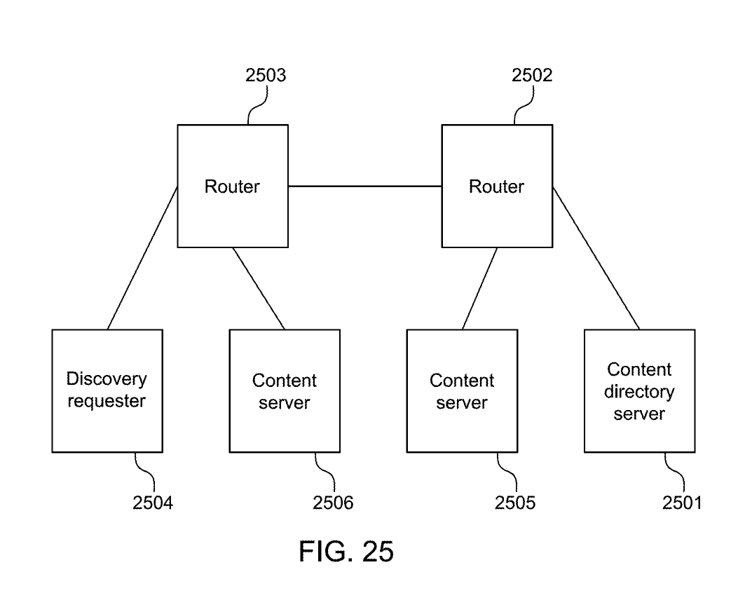

FIG. 25 illustrates an example of information validation using a simple network topology with 6 nodes. Node 2504 is a discovery requester. Node 2501 is a content directory server. Nodes 2502 and 2503 are intermediate nodes (routers) between node 2501 and node 2504. Nodes 2505 and 2506 are content servers.

Node 2504 may want to retrieve a content with ID: contentID1, but it may not know the location of the content initially. As a result, Node 2504 may need to discover the location of the content firstly from the content directory server Node 2501. Node 2501 may maintain the locations of the content (Content Server Node 2505 and Node 2506) and may reply to Node 2504 with the formulated discovery information. The discovery information may be formed with the formats described above. The field queryInfoID may contain the identifier of the content (contentID1). The field queryInfoType may contain the category of the information being discovered, which may be IoT Content. The fields queryInfoID/queryInfoType may link the discovery information to the content. Node 2502 may choose to cache the discovery information when it is forwarded towards node 2504. Node 2504 may choose the Content Server Node 2506 to retrieve the content, which may be nearer to Node 2504 compared to the Content Server Node 2505. Later the Content Server Node 2505 may choose to remove the content from its storage and may broadcast the deletion of the content to the neighboring nodes. When Node 2502 receives the deletion notification, it may automatically invalidate the discovery information that was previously cached. On the other hand, Node 2502 may also intelligently modify the representation in the discovery information by removing Node 2505 from the location list, such that the discovery information may still be valid for future queries.

The proposed information model with embedded relationships between things may enable distributed data storage.

FIG. 26 illustrates an example of distributed data storage, where an example video content 2600 may be composed of three clips: Clip 1 2605, Clip 2 2610 and Clip 3 2615. Using the proposed information model, the relationship among this information may be indicated by the field derivesTo 2620, 2625, 2630 of Clip1 2605, Clip2 2610 and Clip 3 2615 respectively. In the other direction, the video content 2600 may be related to Clip 1 2605, Clip 2 2610 and Clip 3 2615 by the derivedFrom field 2635, 2640, 2645 respectively of the video content 2600. By using the links between the content and its components, the video content 2600 may be distributed and stored in different locations, in this example, in Server 1 2650, Server 2 2655 and Server 3 2660. Whenever the video content is requested, it may trigger Clip 1 2605, Clip 2 2610 and Clip 3 2615 to be retrieved individually from Server 1 2650, Server 2 2655 and Server 3 2660. If any of Server 1 2650, Server 2 2655 and Server 3 2660 fails, some of the clips 2605, 2610, 2615 of the video 2600 may still be retrieved from the other functioning servers, avoiding a situation where the video content is completely unavailable to the requester.

Various numbered embodiments are provided below.

### Embodiments

1. A method for communication in an Internet of Things (IoT), the method comprising:
   receiving a first information over a communications medium by an IoT entity which comprises a processor;
   wherein the first information comprises a first instance of a category of information;
   wherein the first instance comprises a field; and,
   processing, by the IoT entity, the information in accordance with the first instance;
   wherein the first instance comprises an information category selected from the group consisting of content, context, policy, decision, event, discovery, and descriptor.
2. The method of embodiment 1, wherein the field relates to a second instance of a category of information.
3. The method of any one of embodiments 1 or 2, wherein the first instance and the second instance comprise a shared field.
4. The method of any one of embodiments 1-3, wherein the field comprises a pointer to a resource.
5. The method of any one of embodiments 1-4, wherein the first instance comprises a content category and field information selected from the group consisting of
a statistic relating to an access frequency of the first information, and
a location where the first information may reside.
6. The method of any one of embodiments 1-5, wherein the first instance comprises a context category and field information selected from the group consisting of
a rule by which the first information is derived,
a statistic relating to an access frequency of the first information, and
a location where the first information may reside.
7. The method of any one of embodiments 1-6, wherein the first instance comprises a policy category and field information selected from the group consisting of
a purpose of the first information,
an entity affected by the first information,
a condition under which the first information is processed,
a decision that is made on a condition that the condition is satisfied, and
a reference from which at least a part of the information is derived.
8. The method of any one of embodiments 1-7, wherein the first instance comprises a decision category and field information selected from the group consisting of
a purpose of the first information,
a trigger for processing the first information,
an executor designated to process the first information,
a recipient, other than the executor, designated to receive a notification relating to processing of the first information,
an entity affected by the first information, and
an action to be taken by the recipient.
9. The method of any one of embodiments 1-8, wherein the first instance comprises an event category and field information selected from the group consisting of
an entity affected by the first information,
a location at which an event relating to the first information occurs,
a time at which an event relating to the first information occurs, and
a time during which an event relating to the first information occurs.
10. The method of any one of embodiments 1-9, wherein the first instance comprises a discovery category and field information selected from the group consisting of
an identity of information relating to sought information,
a type of information sought,
an identity of an entity seeking information,
a time at which a discovery query is made,
a location from where a discovery query is made,
at least one keyword relating to sought information, and
an identity of an entity who replies to a discovery query.
11. The method of any one of embodiments 1-10, wherein the first instance comprises a descriptor category and field information selected from the group consisting of
an identity of an entity relating to the first information,
a type of the first information, and,
a list containing identity information for at least one item related to the entity, the at least one item being selected from the group consisting of an application, a service, a capability, a functionality, a content, a context, a policy, a decision, an event, a discovery, a descriptor, and an interface.
12. A method for communication in an Internet of Things (IoT), the method comprising:
generating a first information which comprises a first instance of a category of information;
wherein the first instance comprises a field; and,
transmitting the first information over a communications medium to an IoT entity which comprises a processor for processing the first information in accordance with the first instance;
   wherein the first instance comprises an information category selected from the group consisting of content, context, policy, decision, event, discovery, and descriptor.
13. The method of embodiment 12, wherein the field relates to a second instance of a category of information.
14. The method of any one of embodiments 12 or 13, wherein the first instance and the second instance comprise a shared field.
15. The method of any one of embodiments 12-14, wherein the field comprises a pointer to a resource.
16. The method of any one of embodiments 12-15, wherein the first instance comprises a content category and field information selected from the group consisting of
a statistic relating to an access frequency of the first information, and
a location where the first information may reside.
17. The method of any one of embodiments 12-16, wherein the first instance comprises a context category and field information selected from the group consisting of
a rule by which the first information is derived,
a statistic relating to an access frequency of the first information, and
a location where the first information may reside.
18. The method of any one of embodiments 12-17, wherein the first instance comprises a policy category and field information selected from the group consisting of
a purpose of the first information,
an entity affected by the first information,
a condition under which the first information is processed,
a decision that is made on a condition that the condition is satisfied, and
a reference from which at least a part of the information is derived.
19. The method of any one of embodiments 12-18, wherein the first instance comprises a decision category and field information selected from the group consisting of
a purpose of the first information,
a trigger for processing the first information,
an executor designated to process the first information,
a recipient, other than the executor, designated to receive a notification relating to processing of the first information,
an entity affected by the first information, and
an action to be taken by the recipient.
20. The method any one of embodiments 12-19, wherein the first instance comprises an event category and field information selected from the group consisting of
an entity affected by the first information,
a location at which an event relating to the first information occurs,
a time at which an event relating to the first information occurs, and
a time during which an event relating to the first information occurs.
21. The method of any one of embodiments 12-20 wherein the first instance comprises a discovery category and field information selected from the group consisting of
an identity of information relating to sought information,
a type of information sought,
an identity of an entity seeking information,
a time at which a discovery query is made,
a location from where a discovery query is made,
at least one keyword relating to sought information, and
an identity of an entity who replies to a discovery query.
22. The method of any one of embodiments 12-21, wherein the first instance comprises a descriptor category and field information selected from the group consisting of
an identity of an entity relating to the first information,
a type of the first information, and,
a list containing identity information for at least one item related to the entity, the at least one item being selected from the group consisting of an application, a service, a capability, a functionality, a content, a context, a policy, a decision, an event, a discovery, a descriptor, and an interface.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-22. (canceled)

23. A method of an Internet of Things (IoT) communication, the method comprising:
receiving, by an IoT entity, a first information over a communications medium;
wherein the first information comprises a first instance of a category of information, the category of information selected from a first group comprising content, context, policy, decision, event, discovery, and descriptor, the first information comprising an indicator of the category of information; and,
processing, by the IoT entity, the first information based on the category of information.

24. The method of claim 23, wherein the first instance further comprises at least one of a first field associated with a second instance of the category of information or a second field comprising a pointer to a resource.

25. The method of claim 24, wherein the first instance and the second instance further comprise a shared field.

26. The method of claim 23, wherein the first instance further comprises a content category and field information selected from a second group comprising:
a statistic associated with an access frequency of the first information, and
a location of the first information.

27. The method of claim 23, wherein the first instance comprises a context category and field information selected from a second group comprising:
a rule for deriving the first information,
a statistic associated with an access frequency of the first information, and
a location of the first information.

28. The method of claim 23, wherein the first instance further comprises a policy category and field information selected from a second group comprising:
a purpose of the first information,
an entity affected by the first information,
a condition for processing the first information,
a decision that is made when the condition is satisfied, and
a reference from which at least a part of the information is derived.

29. The method of claim 23, wherein the first instance further comprises a decision category and field information selected from a second group comprising:
a purpose of the first information,
a trigger for processing the first information,
an executor designated to process the first information,
a recipient, other than the executor, designated to receive a notification associated with processing of the first information,
an entity affected by the first information, and
an action to be taken by the recipient.

30. The method of claim 23, wherein the first instance further comprises an event category and field information selected from a second group comprising:
an entity affected by the first information,
a location at which an event associated with the first information occurs,
a first time at which the event associated with the first information occurs, and
a second time during which the event associated with the first information occurs.

31. The method of claim 23, wherein the first instance further comprises a discovery category and field information selected from a second group comprising:
a first identity of information associated with sought information,
a type of information sought,
a second identity of an entity seeking information,
a time at which a discovery query is made,
a location from where the discovery query is made,
a keyword associated with sought information, and
a third identity of an entity that replies to the discovery query.

32. The method of claim 23, wherein the first instance further comprises a descriptor category and field information selected from a second group comprising:
an identity of an entity associated with the first information,
a type of the first information, and
a list comprising identity information for at least one item associated with the entity, the at least one item being selected from a third group comprising an application, a service, a capability, a functionality, a content, a context, a policy, a decision, an event, a discovery, a descriptor, and an interface.

33. A method of an Internet of Things (IoT) communication, the method comprising:
generating, via an IoT entity, a first information comprising a first instance of a category of information according to which the first information is processed, the category of information selected from a first group comprising content, context, policy, decision, event, discovery, and descriptor, the first information comprising an indicator of the category of information; and,
transmitting the first information over a communications medium.

34. The method of claim 33, wherein the first instance further comprises at least one of a first field that relates to a second instance of a category of information or a second field comprising a pointer to a resource.

35. The method of claim 34, wherein the first instance and the second instance further comprise a shared field.

36. The method of claim 33, wherein the first instance further comprises a content category and field information selected from a second group comprising:
a statistic associated with an access frequency of the first information, and
a location of the first information.

37. The method of claim 33, wherein the first instance further comprises a context category and field information selected from a second group comprising:
a rule for deriving the first information,
a statistic associated with an access frequency of the first information, and
a location of the first information.

38. The method of claim 33, wherein the first instance comprises a policy category and field information selected from a second group comprising:
a purpose of the first information,
an entity affected by the first information,
a condition for processing the first information,
a decision that is made when the condition is satisfied, and
a reference from which at least a part of the information is derived.

39. The method of claim 33, wherein the first instance comprises a decision category and field information selected from a second group comprising:
a purpose of the first information,
a trigger for processing the first information,
an executor designated to process the first information,
a recipient, other than the executor, designated to receive a notification associated with processing of the first information,
an entity affected by the first information, and
an action to be taken by the recipient.

40. The method of claim 33, wherein the first instance further comprises an event category and field information selected from a second group comprising:
an entity affected by the first information,
a location at which an event associated with the first information occurs,
a first time at which the event associated with the first information occurs, and
a second time during which the event associated with the first information occurs.

41. The method of claim 33, wherein the first instance further comprises a discovery category and field information selected from a second group comprising:
a first identity of information associated with sought information,
a type of information sought,
a second identity of an entity seeking information,
a time at which a discovery query is made,
a location from where the discovery query is made,
a keyword associated with sought information, and
a third identity of an entity that replies to the discovery query.

42. The method of claim 33, wherein the first instance further comprises a descriptor category and field information selected from a second group comprising:
an identity of an entity associated with the first information,
a type of the first information, and
a list comprising identity information for at least one item associated with the entity, the at least one item being selected from a third group comprising an application, a service, a capability, a functionality, a content, a context, a policy, a decision, an event, a discovery, a descriptor, and an interface.
